(19) United States
(12) Patent Application Publication
(10) Pub. No.: US 2023/0298244 A1
(43) Pub. Date: Sep. 21, 2023

(54) AI Curation and Customization of Artificial Reality

(71) Applicant: Meta Platforms Technologies, LLC, Menlo Park, CA (US)

(72) Inventors: Chun-Wei CHAN, Foster City, CA (US); Meng WANG, Hoboken, NJ (US); Maria Alejandra RUIZ GUTIERREZ, New York, NY (US); Michelle Jia-Ying CHEUNG, Wailuku, HI (US); Jiemin ZHANG, Sunnyvale, CA (US); Vincent Charles CHEUNG, San Carlos, CA (US)

(73) Assignee: Meta Platforms Technologies, LLC, Menlo Park, CA (US)

(21) Appl. No.: 18/304,994

(22) Filed: Apr. 21, 2023

Related U.S. Application Data
(60) Provisional application No. 63/382,180, filed on Nov. 3, 2022.
(60) Provisional application No. 63/358,646, filed on Jul. 6, 2022.
(60) Provisional application No. 63/358,648, filed on Jul. 6, 2022.
(60) Provisional application No. 63/356,563, filed on Jun. 29, 2022.

(51) Int. Cl. G06T 13/40; G06T 7/90

(52) U.S. Cl. CPC G06T 13/40; G06T 7/90; G06T 2207/20081

(57) ABSTRACT

In some implementations, the disclosed systems and methods can create a customized pet avatar by applying artificial intelligence to photographs and videos of a real-world pet. In some implementations, the disclosed systems and methods can geospatially map user-generated content within a VR environment. In some implementations, the disclosed systems and methods can receive user-generated content (e.g., images, videos, text, etc.) about a particular destination, such as a business listing, restaurant, or other location of interest. In some implementations, the disclosed systems and methods can build a selected virtual object of a plurality of virtual objects in an artificial reality world.

### CROSS REFERENCE TO RELATED APPLICATIONS

This application claims priority to U.S. Provisional Application Nos. 63/356,563 filed Jun. 29, 2022 and titled “Customized Pet Avatars Using Artificial Intelligence,” 63/358,646 filed Jul. 6, 2022 and titled “Virtual Reality Travel Recommendations,” 63/358,648 filed Jul. 6, 2022 and titled “Artificial Reality Travel Experiences,” and 63/382,180 filed Nov. 3, 2022 and titled “Artificial Intelligence-Assisted Virtual Object Builder Presenting Options.” Each patent application listed above is incorporated herein by reference in their entireties.

### BACKGROUND

In the online community, avatars are graphical representations of users used as icons in gaming and on social networking systems. Avatars can be two-dimensional as displayed on a website or a television screen, or three-dimensional as displayed in an artificial reality (XR) environment. Further, avatars can be static or moveable to a variety of different poses, positions, and gestures. Although avatars can be created based on fictional characteristics, many users create their avatars to reflect their real-world physical traits, such as their face shape, skin tone, eye color, hair color, body type, and the like. To provide a further customizable experience, many avatars can be further personalized to reflect a user's unique style, such as by allowing selection of clothing and accessories. Thus, users can create their avatars to be highly customized online expressions of themselves.

Users typically research travel destinations using books, travel websites, and/or web mapping platforms. For example, prior to visiting a new city, a user can look up restaurants, bars, venues, and/or other activities from traditional sources, which may include user-generated content like photos, videos, and reviews about each establishment. However, some destinations can have a large number of potential destinations to visit, which traditionally has required users (or their agents) to do extensive research when planning a trip to a new location. Typically, the goal of such research is to find restaurants, attractions, and activities that simultaneously meet the interests of a particular individual, are well rated by others, and satisfy any applicable travel constraints (e.g., group size, family friendly, accommodates persons with disabilities, etc.). Given the often overwhelming number of destinations in a given city or area, manually creating an itinerary that meets the needs of a given person or group can be tedious and time-consuming—with some electing to hire a travel agency to assist in this task.

Users typically research travel destinations using books, travel websites, and/or web mapping platforms. For example, prior to visiting a new city, a user can look up restaurants, bars, venues, and/or other activities from traditional sources, which may include user-generated content like photos, videos, and reviews about each establishment. However, it can be difficult for users to contextualize (e.g., determine an establishment's or destination's location, assess that location with respect to a landmark or other destination, etc.) each activity when viewing them as a list or as pins on a 2D map. In addition, it can be difficult to locate some establishments from an address or 2D map, such as those in high-rise buildings or those with entrances that are not along a main street. Put another way, it can be difficult for users to understand what a specific travel experience will be like merely from reviews, pictures, and maps, without additional context.

Many people are turning to the promise of artificial reality (“XR”): XR worlds expand users' experiences beyond their real world, allow them to learn and play in new ways, and help them connect with other people. An XR world becomes familiar when its users customize it with objects that interact among themselves and with the users. While creating some objects in an XR world can be simple, as objects get more complex, the skills needed for creating them increase until only experts can create multi-faceted objects such as a house. To create an entire XR world can take weeks or months of for a team of experts. As XR worlds become more photorealistic, and as the objects within them provide richer interactive experiences, the effort to successfully create them increases even more until some creation is beyond the scope, or the resources, of many, even experts.

### SUMMARY

Aspects of the present disclosure are directed to creating a customized pet avatar by applying artificial intelligence to photographs and videos of a real-world pet. The images and videos can be analyzed to identify physical and behavioral features of the pet. The physical features can be compared to predetermined graphical pet models to determine if a sufficient match exists. If a sufficient match exists, the color and/or color pattern of the pet can be applied to the predetermined graphical model, and the predetermined graphical model can be used as the avatar for the pet. If a sufficient match is not found in the database, a generic graphical model of the type of pet can be modified with the physical features of the pet. The behavioral features can also be applied to the pet, to have it move and act similarly to the pet depicted in the videos.

Aspects of the present disclosure are directed to generating itineraries or travel recommendations based on historical trip data representing the paths of past users in a particular area or location. An itinerary recommendation engine can include one or more time-dependent models trained using data from past users' travel activities (e.g., user-generated content such as photos, videos, and/or reviews) to learn the paths of various users that have traveled about within an area. The engine can identify common paths between popular destinations in an area, and may associate certain paths with particular user characteristics, seasonality, or other factors. A request from a user containing travel constraints and other information to the engine can trigger the engine to generate an itinerary for the user, to thereby automatically provide travel recommendations to the user. The generated itinerary can be visualized in a VR environment for review by the user.

Aspects of the present disclosure are directed to creating an interactive virtual reality (VR) environment of a real-world location with real-world content positioned in context within the environment. A geospatial mapping system can receive user-generated content (e.g., images, videos, text, etc.) about a particular destination, such as a business listing, restaurant, or other location of interest. The geospatial mapping system analyzes the data and/or metadata of the user-generated content to determine a georeference within the VR environment. A content overlay system can render virtual objects representing the user-generated content based on their respective georeferences within a VR environment of a real-world location, thereby creating an artificial reality travel experience.

Aspects of the present disclosure are directed to an artificial intelligence (AI)-assisted virtual object builder in an artificial reality (XR) world. The AI builder can respond to a user command (e.g., verbal and/or gestural) to build virtual objects in the XR world. If the user command to build a virtual object is ambiguous, the AI builder can present virtual object options consistent with an object type identified by the user command. In some implementations, the AI builder can further present contextual information regarding the object type and/or the virtual object options. Upon selection of one of the virtual object options, the AI builder can build the virtual object in the XR world at a virtual location specified by the user command.

### BRIEF DESCRIPTION OF THE DRAWINGS

FIG. 1 is an example of a composite avatar including a user avatar and a customized pet avatar.

FIG. 2 is an example of photographs that can be input into a customized pet avatar system.

FIG. 3 is an example of samples of a video that can be input into a customized pet avatar system.

FIG. 4 is an example of graphical models of breeds of dogs that can be stored in a database.

FIG. 5 is an example of a customized pet avatar created using artificial intelligence.

FIG. 6 is a flow diagram illustrating a process used in some implementations for creating a customized pet avatar using artificial intelligence.

FIG. 7 is a conceptual diagram illustrating an example trip of an individual that met a friend part way through their travel day.

FIG. 8 is a conceptual diagram illustrating an example trip of a couple on a date with multiple weather-dependent branches.

FIG. 9 is a conceptual diagram illustrating an example trip of a family, with different branches based on the season.

FIG. 10 is a conceptual diagram illustrating an example trip for a person with a disability.

FIG. 11 is a schematic diagram illustrating examples inputs to and outputs from an itinerary recommendation engine.

FIG. 12 is a conceptual diagram illustrating an example virtual reality environment with automatically-generated travel recommendation rendered in context.

FIG. 13 is a flow diagram illustrating a process for automatically generating a travel itinerary for a user based on historical trip data.

FIG. 14 is a conceptual diagram illustrating an example artificial reality travel experience with in-context photo content.

FIG. 15 is a conceptual diagram illustrating an example artificial reality travel experience with in-context photo and summary content.

FIG. 16 is a conceptual diagram illustrating an example artificial reality travel experience with in-context photo content viewed from a distant vantage point.

FIG. 17 is a conceptual diagram illustrating an example artificial reality travel experience with in-context summary content.

FIG. 18 is a conceptual diagram illustrating an example geospatial mapping process.

FIG. 19 is a flow diagram illustrating a process for generating georeferences for displaying in-context user-generated content in a VR environment.

FIG. 20A is a conceptual diagram of an example artificial reality (XR) world in which a user is making an object build command to an artificial intelligence (AI) builder.

FIG. 20B is a conceptual diagram of an example XR world in which an AI builder is presenting options of candidate virtual objects and contextual information based on an object build command.

FIG. 20C is a conceptual diagram of an example XR world in which a user is selecting a virtual object from the candidate virtual objects.

FIG. 20D is a conceptual diagram of an example XR world in which an AI builder is building the selected virtual object in the XR world according to a virtual location identified from an object build command.

FIG. 20E is a conceptual diagram of an example XR world in which a user is making a further object build command to an AI builder.

FIG. 20F is a conceptual diagram of an example XR world in which an AI builder is building a further selected virtual object in the XR world according to a virtual location identified from a further object build command.

FIG. 21 is a flow diagram illustrating a process used in some implementations for building a selected virtual object, of a plurality of virtual objects, in an XR world.

FIG. 22 is a block diagram illustrating an overview of devices on which some implementations of the present technology can operate.

FIG. 23 is a block diagram illustrating an overview of an environment in which some implementations of the present technology can operate.

### DESCRIPTION

Aspects of the present disclosure are directed to creating a customized pet avatar using artificial intelligence. The pet avatar can be customized to a user's real-world pet using images of the pet from photographs and/or videos. The images can be analyzed to identify physical features of the pet. The physical features can include one or more of hair color, color pattern, number of legs, build, proportions, size, weight, height, length of hair, length of tail, eye color, facial layout, facial features, etc., and combinations thereof.

Once the physical features of the pet are identified, they can be compared to predetermined graphical models of pets in a database to determine if a sufficient match exists between the pet and an existing graphical model. If a sufficient match exists, the color and/or color pattern of the pet can be applied to the predetermined graphical model, and the predetermined graphical model can be used as the avatar for the pet.

If a sufficient match is not found in the database, a generic graphical model of the type of pet can be modified with the physical features of the pet to create a new graphical model reflective of the pet. The new graphical model can then be used as the avatar for the pet.

Although described herein as a “pet”, it is contemplated that the pet described herein can be any domesticated or wild animal, including a cat, a dog, a fish, a snake, a lizard, a hamster, a rabbit, a farm animal, or even a zoo animal. Further, it is contemplated that the methods described herein can be applied to more than one pet to create multiple customized pet avatars. The pet avatar(s) can be displayed alone, or can be displayed alongside the pet owner's avatar, as described further herein.

The customized pet avatar can be two-dimensional or three-dimensional. For example, the customized pet avatar can be displayed in a profile picture on a social networking system, or can be exported to an artificial reality (XR) environment. Further, the customized pet avatar can be static or can move and interact with other avatars and items within an XR environment.

In some implementations, the customized pet avatar can be created from a video of the real-world pet. Some implementations described herein can analyze the video to extract individualized information about the real-world pet that can be applied to the customized pet avatar. For example, some implementations can extract pet movement profiles, personality profiles, and/or abilities of the particular real-world pet (e.g., movements performed on command) in order to further customize the pet avatar. Alternatively or additionally, a user can select the abilities of the customized pet avatar from a list of pre-defined abilities (e.g., sit, lay down, roll over, jump through hoop, shake, etc.).

As described further herein, some implementations can create a unique non-fungible token (NFT) associated with the customized pet avatar. The NFT can include NFT extras having a variety of information about the customized pet avatar, including its creator, its look, its movement profile, its current offered sale price, past selling prices, owner information, user permissions, where the NFT has been posted, etc.

In some implementations, a user can breed two customized pet avatars. Breeding two customized pet avatars can create a new pet avatar that takes some characteristics from each customized pet avatar, or morphs the characteristics of the two customized pet avatars according to one or more weighting factors to create the new pet avatar. An NFT can also be minted for the new pet avatar.

Existing pet avatar systems merely allow a user to select a preexisting pet avatar from a database of generic pet avatars. Thus, many users may have the same generic pet avatar. The customized pet avatar system and processes disclosed herein overcome these problems with existing systems by creating a pet avatar based on images of a user's real-world pet. This allows each user to have a customized pet avatar unique to the user and reflective of the user's own pet.

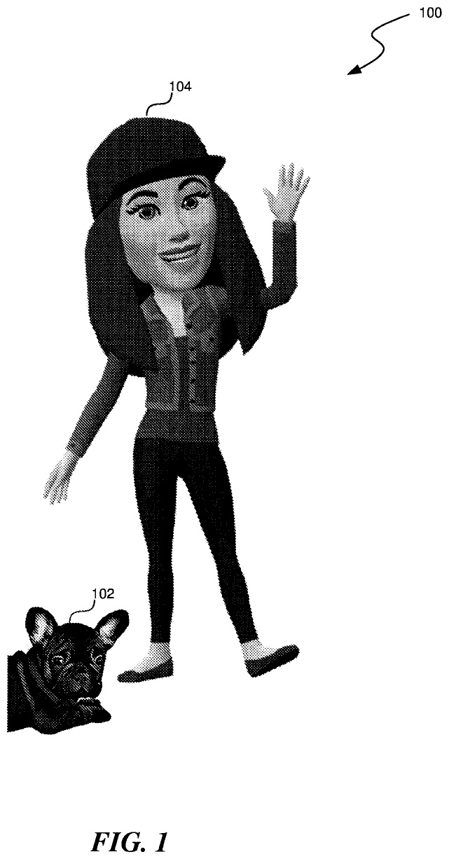

Several implementations are discussed below in more detail with reference to the figures. FIG. 1 is an example of a composite avatar 100 including a user avatar 104 and a customized pet avatar 102. In some implementations, user avatar 104 can reflect real-world physical traits of the user, such as her face shape, skin tone, eye color, hair color, body type, and the like, as well as her clothing and accessories. In order for the user to more highly customize her icon, composite avatar 100 can be created with both user avatar 104 and customized pet avatar 102, the latter of which can be reflective of the real-world physical traits of the user's pet. In this example, customized pet avatar 102 is created based on the user's black-and-white French Bulldog.

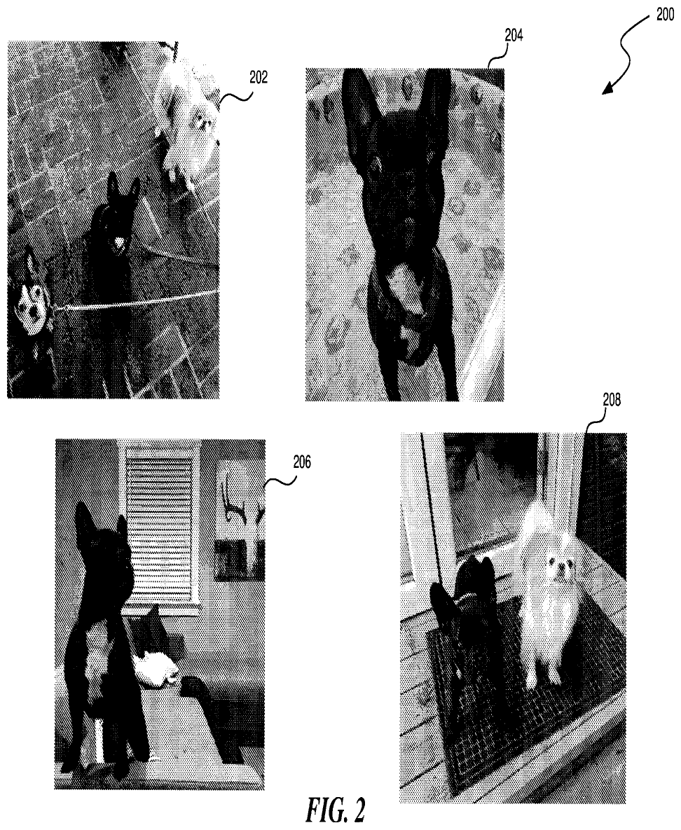

FIG. 2 is an example of photographs 200 that can be input into a customized pet avatar system. Photographs 200 can include images of the pet in different angles and poses that are used to create the customized pet avatar. By using multiple photographs of the pet, the physical features of the pet can be more accurately and comprehensively identified using artificial intelligence and machine learning techniques.

Photographs 200 can include images of the pet alone, such as in photographs 204 and 206, or along with other pets, such as in photographs 202 and 208. In order for the customized pet avatar system to ascertain which pet the user desires to include in the customized pet avatar, the user can select the desired pet from one or more of photographs 200 in some implementations. In some implementations, the customized pet avatar system can identify the desired pet by selecting the pet that is alone in one or more images, such as in photographs 204 and 206. In some implementations, the customized pet avatar system can identify the desired pet by analyzing photographs 200 to determine the most common pet in the images. For example, the customized pet avatar system can determine that the French Bulldog is the desired pet because it is included in 100% of photographs 200, while the Japanese Chin is included in only 50% of photographs 200, and the Boston Terrier is included in only 25% of the photographs 200.

In some implementations, the customized pet avatar system can identify that the user has more than one pet. For example, in FIG. 2, the customized pet avatar system can determine that both the French Bulldog and the Japanese Chin are desired pets for customized pet avatars, and can create customized pet avatars for both pets using the processes described herein.

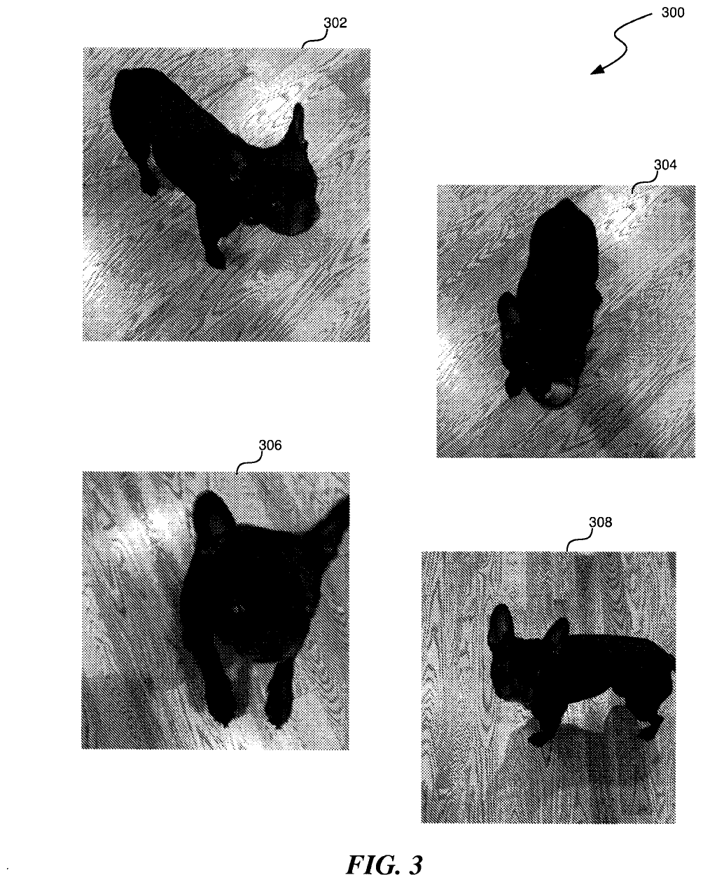

FIG. 3 is an example of samples 300 of a video that can be input into a customized pet avatar system. Samples 300 can be taken to show the pet in various poses and at different angles in order to identify its physical features using artificial intelligence and machine learning techniques.

In addition, the video from which samples 300 were obtained can be analyzed using artificial intelligence and machine learning techniques to determine movement characteristics of the pet, such as the pet's gait and mannerisms, as well as the pet's capability to perform particular gestures. For example, the video can be analyzed to determine whether the pet is able to perform certain abilities on demand, such as sitting, lying down, rolling over, etc. These movement characteristics of the pet can be used to further customize the pet avatar to move in similar ways or to have similar abilities as the real-world pet.

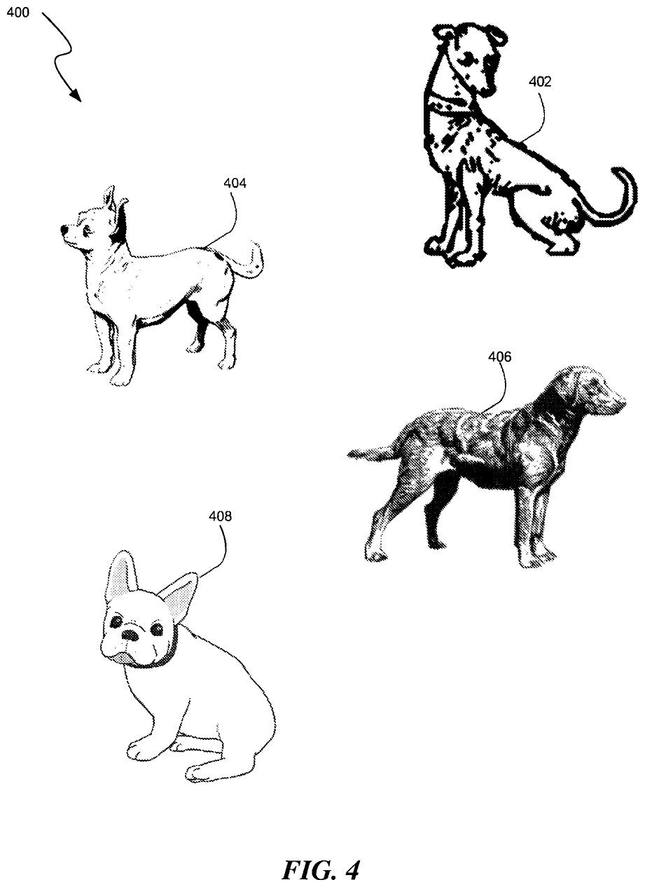

FIG. 4 is an example of graphical models 400 of breeds of dogs that can be stored in a database. In this example, graphical models 400 include a Dalmatian 402, a Chihuahua 404, a Golden Retriever 406, and a French Bulldog 408. The customized pet avatar system can compare the identified physical features of the pet identified through photographs and videos to graphical models 400. Although shown and described in this example with respect to breeds of dogs, it is contemplated that graphical models 400 may include other animals as well.

The customized pet avatar system can determine whether one of graphical models 400 was found in the database matching the identified physical features of the pet. In this example, the customized pet avatar system may select French Bulldog 408. Although the color of French Bulldog 408 is inconsistent with that of the pet, it is contemplated that the threshold for matching can be lower than 100% to account for some inconsistencies.

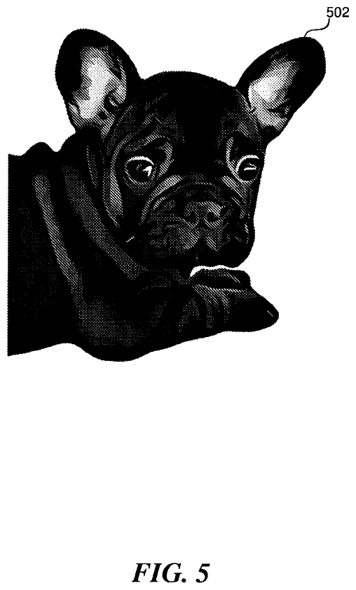

FIG. 5 is an example of a customized pet avatar 502 of the pet from the above described Figures created using artificial intelligence. Once the graphical model of a French Bulldog is identified as closely matching the physical features of the pet, the color and color pattern of the pet can be applied to the graphical model to a create customized pet avatar 502. The customized pet avatar 502 now uniquely reflects the pet shown in the user-provided photographs and videos.

Once created, the customized pet avatar 502 can be used with a composite avatar or can be displayed on its own, as shown in FIG. 5. In either implementation, it is contemplated that the customized pet avatar 502 can be static or dynamic. For example, the customized pet avatar 502 can move consistent with the movement characteristics identified from video of the pet or to perform abilities similar to those shown in the video. The customized pet avatar 502 can also move according to preset movement profiles and have preset abilities. In some implementations, the customized pet avatar 502 can be created without innate abilities, and a user can train the customized pet avatar 502 to perform certain functions over time or through payment of a fee to the customized pet avatar system.

In some implementations, a non-fungible token (NFT) can be created for the customized pet avatar 502. NFTs are blockchain-backed identifiers specifying a unique (digital or real-world) item; in this case, the customized pet avatar 502. Through a distributed ledger, the ownership of these tokens can be tracked and verified. Such tokens can link to a representation of the unique item, e.g., via a traditional URL or a distributed file system such as IPFS. While a variety of blockchain systems support NFTs, common platforms that supports NFT exchange allow for the creation of unique and indivisible NFT tokens. Because these tokens are unique, they can represent items such as art, 3D models, virtual accessories, etc.

The NFT can include NFT extras through linking and expanding NFT data structures. NFT extras can include a variety of information about the NFT, including the creator of the customized pet avatar 502, the look of the customized pet avatar 502, the movement profile of the customized pet avatar 502, a current offered sale price, past selling prices, contact information for a current owner, user permissions for the NFT, where the NFT has been user/posted, etc. When a new NFT is created, some NFT extras can be specified directly in the NFT (stored on-chain) while other NFT extras can be specified as links in the NFT to a location where the extra information is stored (stored off-chain). For example, extras that are unlikely to change between transactions, such as who the NFT creator is and a history of the NFT, can be included as fields in the NFT; while extras that may change, such as a current sale price or NFT use permissions, or are too large to include in the blockchain, such as a messaging thread about the NFT, may have links to a location where these data items are stored. The NFT extras allow for a user interacting with an NFT to discover additional details about the NFT and interact with entities related to the NFT. For example, the user may be able to locate a virtual storefront for the NFT creator to see other NFTs from that creator, join a conversation thread about the NFT, or view a history of ownership of the NFT.

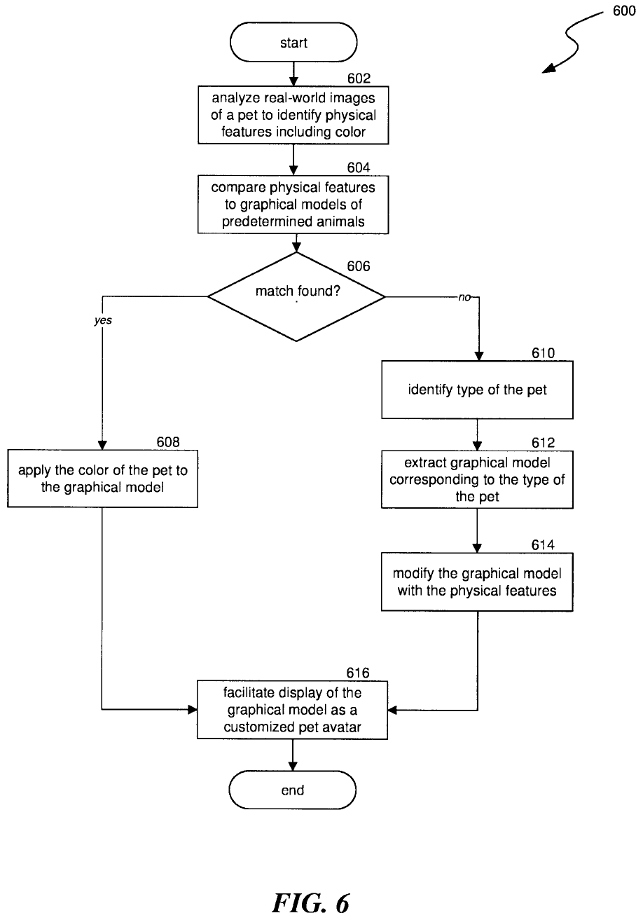

FIG. 6 is a flow diagram illustrating a process 600 used in some implementations for creating a customized pet avatar using artificial intelligence. In some implementations, process 600 can be performed as a response to a user request for a customized pet avatar. In some implementations, process 600 can be performed ahead of time, e.g., by pulling and analyzing photos of a user's pet from social media or other sources without a user's explicit instruction to do so, and the customized pet avatar can be requested or retrieved at a later time.

At block 602, process 600 can analyze real-world images of a pet to identify physical features of the pet. The real-world images can include still photographs and/or videos. Any suitable image and/or video processing techniques may be used in order to identify the physical features of the pet. For example, process 600 may identify from images that a pet has short brown hair, is large in size, has 4 legs, no tail, and a strong build having particular dimensions and proportions. In some implementations, process 600 can further prompt the user to input the type of pet and breed of the pet and use this metadata to more accurately map the physical features of the pet to an existing graphical model in the database at block 604.

At block 604, process 600 can compare the identified physical features of the pet to graphical models of predetermined animals having particular breeds that are stored in a database. For example, the database may include graphical models of a variety of breeds of dogs, as described above.

At block 606, process 600 can determine whether a graphical model was found in the database matching the identified physical features. In some implementations, the threshold for matching can be lower than 100%. For example, process 600 can set a threshold of 75%, such that the physical features of the pet are not entirely consistent with the graphical model to account for variations in individual pets. In some implementations, different thresholds may be set for different features. For example, in order for a match to be found between the physical features of the pet and a graphical model of a Rhodesian Ridgeback, process 600 may require that the pet be red in color without variation.

At block 608, if a match is found at block 606, process 600 can apply the color of the pet as identified by the physical features, as well any available color pattern, to the matching graphical model.

At block 610, if a match is not found at block 606, process 600 can identify the type of the pet. For example, process 600 can compare the identified physical features to generic models of different types of animals, e.g., dogs, cats, fish, etc., to determine the type of pet. At block 612, process 600 can extract the graphical model corresponding to the determined type of the pet, e.g., a generic model of a dog. At block 614, process 600 can modify the graphical model with the identified physical features of the pet. For example, process 600 can make the generic dog model bigger, smaller, heavier, lighter, different colored, short haired, long haired, and the like. In another implementation (not shown), process 600 can determine the closest matching graphical model at block 606 and modify the closest matching graphical model with the identified physical features of the pet. When a new graphical model is created, process 600 can update the database of graphical models to include the new graphical model, along with any metadata associated with the new graphical model, such as type of pet or breed.

At block 616, process 600 can facilitate display of the graphical model as the customized pet avatar. For example, a server or other device performing process 600 can transmit the customized pet avatar to a user device, such as a computer, tablet, or smartphone. At this stage, in some implementations, process 600 can collect feedback from the user regarding whether the customized pet avatar accurately reflects the real-world pet, and if not, what changes should be made. Process 600 can use this feedback to refine its artificial intelligence and machine learning algorithms such that future pets are more accurately mapped to existing graphical models.

It is contemplated that process 600 can be repeated multiple times to create multiple pet avatars customized for a user having multiple pets. For example, a composite avatar may have two customized pet avatars reflecting a male and female dog. In this case, when process 600 facilitates display of the customized pet avatars, process 600 can further display options for breeding the two customized pet avatars in some implementations. Breeding two customized pet avatars can create a new pet avatar that takes some characteristics from each customized pet avatar, or morphs the characteristics of customized pet avatars according to one or more weighting factors to create the new pet avatar. In addition, an NFT can be minted for the new pet avatar according to the process described above.

Advances in machine learning have made it possible to process large amounts of data to identify trends or patterns within that data. With sufficiently large datasets, it is now possible to accurately predict what a particular user might find interesting or relevant based on activity of other users with common characteristics. One application of this machine learning technology involves combining collaborative filtering (i.e., grouping a set of users that have consumed the same products or content) with content filtering (i.e., grouping users by common characteristics and/or preferences) to implement a recommendation engine. As a simple example, if a set of users watched movies A and B, a recommendation engine may suggest to a user who just finished watching movie A that they may also be interested in movie B.

In the domain of travel, there are many different dimensions or parameters that can be used to describe or contextualize the trip of a person or group (hereinafter “traveler”). A traveler visits an area on a particular day, which may be a weekday or weekend, during a particular season, and/or may occur during a particular holiday. A trip includes a sequence of destinations each at different times of day, for different durations, and with potentially varied weather conditions during the visit to each destination. The travelers might have enjoyed their visit to a destination, or alternatively may have considered their visit unsatisfactory. In addition, a person might have visited a destination alone, with a friend or group of friends, with a significant other, or with family. Furthermore, each traveler may be associated with a particular demographic (e.g., based on age, ethnicity, national origin, etc.), and/or might have interests that are explicitly expressed in a user profile or inferred from that user's past activities. The ordered sequence of the destinations is yet another relevant factor to consider in extrapolating travel patterns from historical data (e.g., travelers may be more likely to dine before a late night concert than after).

By factoring in these various dimensions and parameters, patterns of traveler behavior can be modeled. An itinerary recommendation engine trained on historical trip data of various travelers can provide predictions or inferences about the likelihood of whether previous users would have participated in accordance with a particular itinerary. For example, if a user has a two-hour layover in Chicago, what is the likelihood that other users in the past would have gone to a professional baseball game? Based on historical data, the model would likely predict that such an itinerary would be near zero percent based on users typically spending at least three hours when attending a professional baseball game in Chicago. As another example, if the user has a six-hour layover in Chicago, what is the likelihood that other users in the past would have gone to a popular pizza restaurant for deep dish pizza? Based on historical data, the model would probably consider an itinerary involving a stop at deep dish pizza restaurant feasible given the time constraints. In this manner, the model may determine, at a minimum, whether a particular itinerary is even feasible within a set of constraints. When applied generatively, this process of feasibility determination can be used to filter out potential itineraries that might otherwise fit within a given user's preferences.

In addition to filtering infeasible itineraries, the itinerary recommendation engine can perform collaborative filtering to identify historical trips from other users that match a particular user's preferences, past travel destinations, or manually specified travel interests. For instance, consider a user that frequents coffee shops, Italian restaurants, and live music events. The itinerary recommendation engine may be trained on data that includes trips involving some combination of coffee shops, Italian restaurants, and live music venues within a particular city. The engine may generate one or more itineraries based on this historical data, taking into account any constraints pertaining to the user. For instance, if a user visiting New York City is staying in Manhattan, but the top-rated coffee shop is in Brooklyn, the engine may select a coffee shop that is highly rated in closer proximity to the user's accommodations.

In some embodiments, the itinerary recommendation engine may generate an itinerary based on characteristics about the traveler(s) and/or temporal factors, such as season. For instance, historical trip data of activities from families with young children (i.e., family-friendly activities) may not align with the interests of a group of young adult men celebrating someone's birthday (i.e., adult-only activities). As another example, popular activities in a particular city may be significantly different in the summer months compared to the winter months. Thus, the itinerary recommendation engine can employ models that are trained to recommend destinations that are appropriate to the user at a given time of year.

In some cases, historical trip data may be directly captured in a particular application or system (e.g., a reservation system, a travel planner, a user feedback application, etc.). In other cases, historical trip data may be inferred from user-generated content, such as images, videos, text, or some combination thereof about a particular subject. For instance, a user may use a mapping application to get turn-by-turn directions to a restaurant, capture and post a photo of the food they were served at that restaurant, and then write a brief review of their dining experience at that restaurant. The specific restaurant, the duration of the visit, and their review of the restaurant may be inferred from one or more of those pieces of user-generated content. Additionally, metadata such as the user's location according to a mobile device's operating system-based location service may provide additional context from which the user's trip or path can be inferred.

As described herein, the terms “trip data” and “paths” may be used interchangeably to describe an ordered sequence of two or more destinations visited by one or more travelers. For the purposes of this disclosure, the term “destination” refers to a particular business listing, restaurant, or other location of interest. A destination may be associated with an address and/or geolocation, and may be stored as an object or data record in a computing system. Each destination in a path or trip may be associated with a visit duration, one or more travelers who visited that destination in a particular instance, a date and time of the visit, weather conditions during the visit, and/or the traveler(s) rating of their experience at that destination (collectively “destination metadata”), among other possible destination metadata. Example paths are conceptually illustrated and described with respect to the figures below.

As described herein, the term “itinerary” generally refers to a planned sequence of one or more destinations for a particular user or set of users to visit. An itinerary can serve as a “recommendation,” such as when an itinerary recommendation engine has deemed sufficient to meet a particular user's interests within that user's travel constraints. A sufficient recommendation may be an itinerary that is predicted by one or more models of the itinerary recommendation engine to have a likelihood that meets or exceeds some threshold likelihood (e.g., a generated itinerary has at least an 80% likelihood to have been traveled by another traveler with similar characteristics as the user). The manner in which a particular itinerary is scored may vary among different implementations (e.g., the architecture of the model or models used to implement the itinerary recommendation engine).

The conceptual depictions discussed below are of example historical trip data with which an itinerary recommendation engine can be trained. Each box shown in the conceptual depictions represents a destination visited during a particular trip, with the destination itself denoted by the large icon located in the center of each box. At the top left of each destination box is an icon representing the type of traveler or group of travelers that visited the destination. In some destination boxes, the top right corner includes an icon denoting the weather conditions or season when the destination was visited. In each destination box, the bottom right corner includes a stopwatch icon indicating the duration of the visit to that destination. Finally, the face icons at the bottom right corner of each destination box indicates the level of satisfaction of the traveler or travelers with that destination.

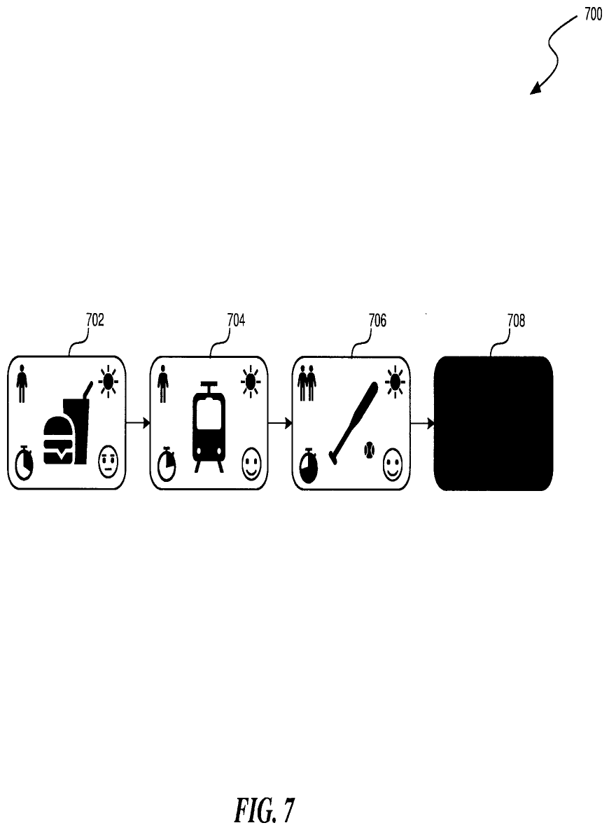

FIG. 7 is a conceptual diagram 700 illustrating an example trip of an individual that met a friend part way through their travel day. During this trip, the individual and friend did not experience any precipitation or adverse weather conditions. The trip began when a single traveler visited a fast food restaurant (destination 702), which they felt neutral about. Then, the traveler rode the public trolley (destination 704), which they enjoyed, on their way to meet a friend to watch a baseball game (destination 706). In the evening after the game, the traveler and friend stopped by a bar (destination 708), which was noisy and dirty—leaving them feeling dissatisfied with their visit.

An itinerary recommendation engine may learn from at least this trip that the fast food restaurant (destination 702) is not highly recommendable, but that the trolley (destination 704) is. In addition, this trip provides a data point that the baseball game is enjoyable when it is not raining, and is (extrapolating from this example) often enjoyed with friends (i.e., since the person met up with the friend for the game). The itinerary recommendation engine may also associate the bar (destination 708) with not being enjoyable—or least not enjoyable directly following a baseball game (e.g., due to being rowdy and crowded with fans after the game). In addition, the itinerary recommendation engine may learn about the amount of time spent at each destination.

If additional similar trips are taken by different travelers, patterns from this type of trip can be identified by the itinerary recommendation engine. For instance, the bar (destination 708) may be commonly enjoyed by visitors who travel there during the day time, or who did not attend a baseball game earlier in the day. In such a case, the itinerary recommendation engine may predict that a user wanting to go to a future baseball game would not enjoy that same bar (destination 708). In this manner, the itinerary recommendation engine can learn not only about which destinations are popularly visited, but also infer relationships from a sequence of destinations (i.e., destination X is generally enjoyed by visitors, unless it is preceded by destination Y).

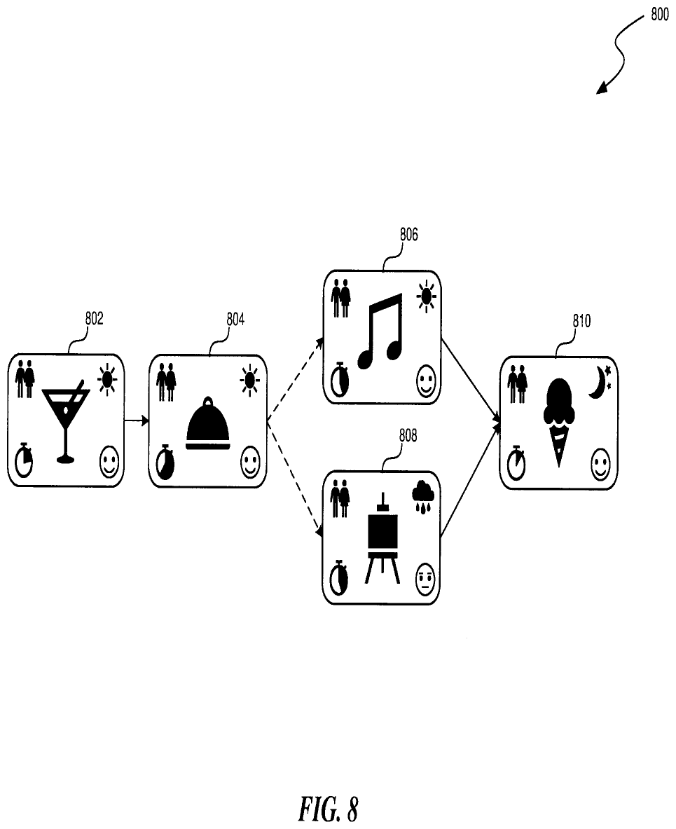

FIG. 8 is a conceptual diagram 800 illustrating an example trip of a couple on a date with multiple weather-dependent branches. This example explores the possibility of the trip diverging based on the weather conditions. The trip starts with the couple visiting a cocktail bar (destination 802) before going to a fine dining restaurant (destination 804) for dinner. In one sequence, the couple went to an outdoor venue to listen to live music (destination 806) when the weather was clear. In an alternative sequence, the couple goes to an art museum (destination 808) when it was raining. In both sequences, the couple then went to a local ice cream shop (destination 810).

An itinerary recommendation engine may learn from at least this trip that the outdoor live music destination is recommendable when the weather permits it. However, when there is precipitation, visiting the art museum is an alternative option for couples. Even though the art museum was not found to be as enjoyable as the live outdoor music, the engine may consider the art museum as a suitable alternative activity (i.e., if it is among the better rated destinations when the weather is poor). Across multiple trips, the engine can identify which destinations are recommended during different weather conditions and dynamically adjust what is deemed satisfactory accordingly (i.e., an average-rated destination might not be recommended when the weather is clear, but is recommended when the weather is poor).

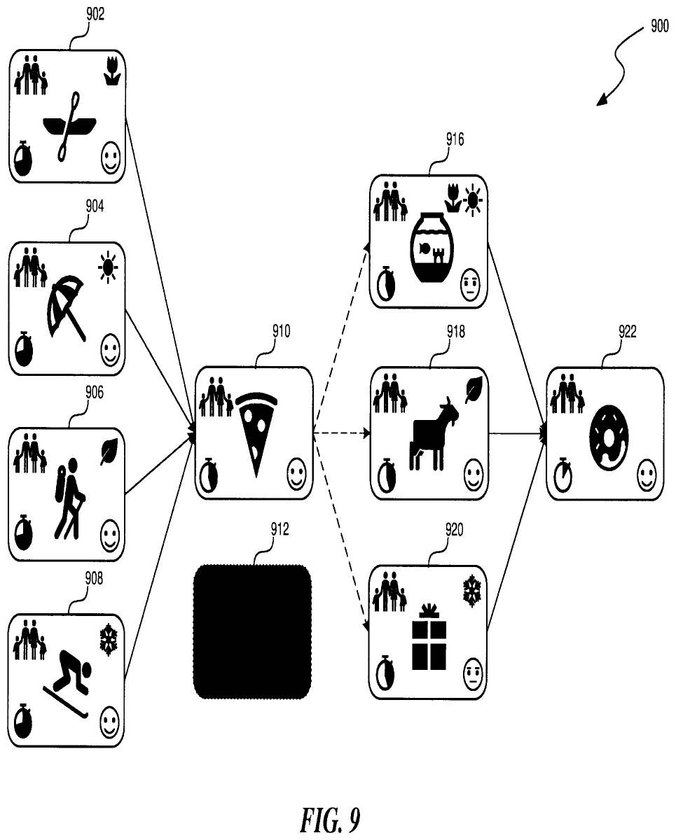

FIG. 9 is a conceptual diagram 900 illustrating an example trip of a family, with different branches based on the season. This example illustrates how seasonality affects which activities may be popular, as well as which activities are popular irrespective of the season. In this example, a family trip may begin with a kayaking activity (destination 902) in the spring, a trip to the beach (destination 904) in the summer, hiking a trail (destination 906) in the fall, or skiing (destination 908) in the winter. A local pizza restaurant (destination 910) may be a popular place for families to stop for lunch after outdoor activities. Then, in the spring and summer, the local aquarium (destination 916) may be frequently visited by families (e.g., if it is raining in spring or too hot in the summer). Alternatively, families may commonly visit a local petting zoo in the fall (destination 918). In the winter, gift shopping (destination 920) might be popular after getting pizza at destination 910. Finally, families might stop by a local donut shop (922) to get dessert to conclude the day of activities.

An itinerary recommendation engine may learn from this historical trip data that certain activities are season-dependent, while others are enjoyed year-round. Thus, the itinerary recommendation engine may generate different itineraries for family trips in different seasons. In addition, FIG. 9 shows that a local hot dog restaurant (destination 912) is poorly reviewed by families. Given that the pizza restaurant is highly rated, the itinerary recommendation engine may generally exclude destination 912 when selecting destinations from which to generate an itinerary. In this manner, user feedback may improve the quality of itineraries generated by the itinerary recommendation engine.

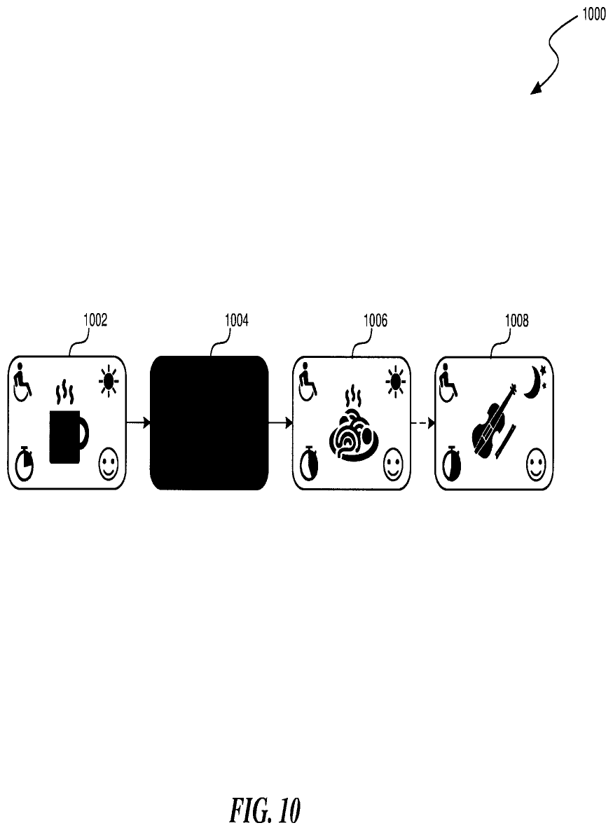

In some cases, a particular traveler may have certain restrictions or constraints that are not applicable to typical travelers (e.g., dietary restrictions, disabilities, sensitivities or risk factors to certain elements such as sun exposure, etc.). FIG. 10 is a conceptual diagram 1000 illustrating an example trip for a person with a disability related to their mobility. This example illustrates how a person with a mobility-related disability might consider an otherwise popular destination to be dissatisfactory because that destination lacks adequate accommodations for persons with disabilities. In this example, the traveler visited and enjoyed a local coffee shop (destination 1002), and then went to ride on the city's trolley car (destination 1004). Despite many positive reviews from other travelers, this traveler was very dissatisfied with the trolley car (e.g., due to a lack of accommodations for persons with disabilities). The traveler then went on to dine at an Italian restaurant (destination 1006), and afterwards attended a symphony (destination 1008).

An itinerary recommendation engine may learn from this historical trip data that certain destinations (e.g., the trolley car) are enjoyable or suitable only for some demographics of travelers, and are unsuitable for others such as persons with disabilities. Thus, destinations which are generally considered popular may be not be recommended by the itinerary recommendation engine for some subset of travelers. In this manner, demographic information or constraints for a particular travel can be used to train one or more models (and subsequently may be provided as inputs into those one or more models) to generate itineraries that are suitable to a particular travel's constraints (e.g., based on user feedback about destinations from other travelers with similar constraints).

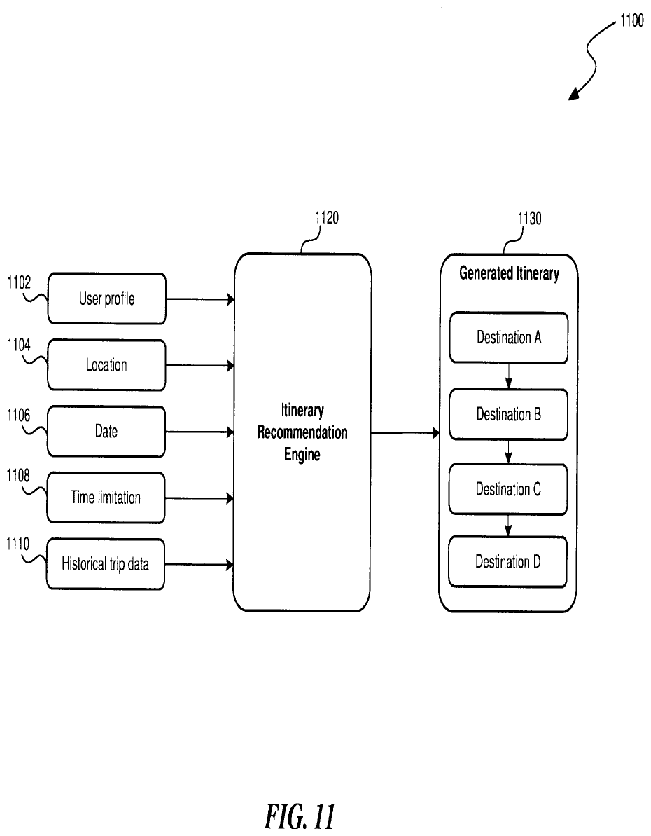

FIG. 11 is a schematic diagram 1100 illustrating examples inputs to and outputs from an itinerary recommendation engine 1120. The itinerary recommendation engine may include one or more machine learning, statistical, or artificial intelligence models trained used historical trip data 1110, examples of which are shown and described herein (e.g., long short-term memory networks, recurrent neural networks, etc.). Once the models are trained and tuned, the itinerary recommendation engine 1120 can receive one or more of the following inputs: a user profile 1102 (e.g., demographic information, user constraints, user preferences, etc.); a location 1104 (e.g., a travel location such as a city or region); a date 1106; and/or a time limitation 1108 (e.g., the duration of a trip being planned). These inputs are received by the itinerary recommendation engine 1120, which predict, forecast, or otherwise automatically generate a generated itinerary 1130.

The generated itinerary 1130 can include an ordered list of destinations, which represent a sequence of recommended destinations or activities for the particular user associated with user profile 1102, around the location 1104, on the date 1106, and/or within the time limitation 1108. In some implementations, the itinerary recommendation engine 1120 may include multiple temporal models trained on subsets of the historical trip data 1110 (e.g., a separate model for different demographic classifications), such that an algorithm or set of heuristics may be used to select the appropriate temporal model with which to generate the generated itinerary 1130. In other implementations, a complex model architecture may be used to implement a large model capable of receiving each of the inputs.

Regardless of the particular implementation, the generated itinerary 1130 can include one or more destinations. In some embodiments, these destinations can be associated with georeferences within a VR environment, such that the generated itinerary 1130 can be reviewed or experienced virtually within a VR application.

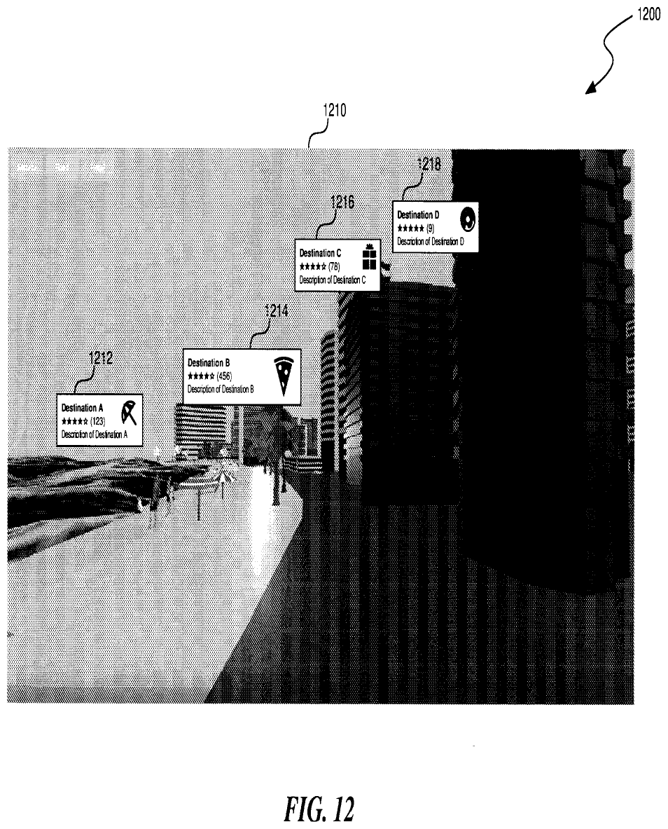

FIG. 12 is a conceptual diagram 1200 illustrating an example virtual reality environment with automatically-generated travel recommendations rendered in context. In this example, a user who typically engages in relaxing activities while traveling wishes to visit a seaside town. A virtual representation of that town can be instantiated as a VR environment designed to approximately match the real-world location, an example of which is shown as frame 1210.

In this example, the generated itinerary includes four destinations: Destination A (a beach, shown as destination 1212); Destination B (a pizza restaurant, shown as destination 1214); Destination C (a gift shop, shown as destination 1216); and Destination D (a donut shop, shown as destination 1218). Information about each of these destinations may be rendered in the VR application “in context” (i.e., proximate to the virtual representation of the respective destination in the VR environment)—thereby allowing the user to intuitively navigate through the VR environment and assess the generated itinerary. In this manner, the user is able to get an intuitive sense of how close each of the destinations are, and also visualize how to navigate between them prior to visiting the location in person.

In some instances, the process of generating the generated itinerary may be triggered automatically when a user is navigating through a VR environment in a VR application. For example, a user might fast travel to a VR city designed like the city of Miami, Florida. This action might trigger the itinerary recommendation engine to automatically generate an itinerary that it is relevant to the user, so that the user can seamlessly visit Miami virtually and begin to review the automatically generated itinerary from within the VR application.

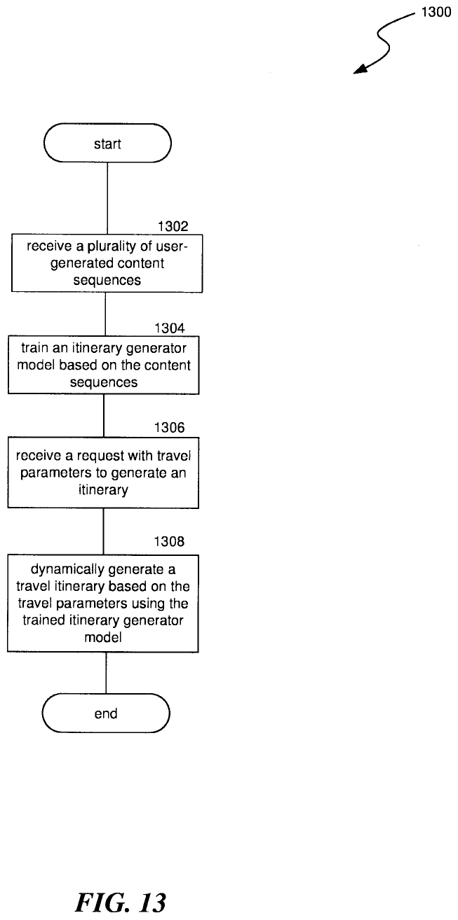

FIG. 13 is a flow diagram illustrating a process 1300 for automatically generating a travel itinerary for a user based on historical trip data. In some implementations, process 1300 can be performed on an artificial reality device, e.g., by a sub-process of the operating system, by an environment control “shell” system, or by an executed application in control of displaying one or more objects in an artificial reality environment. In other cases, process 1300 can be performed on a server system, e.g., supporting itinerary display on an artificial reality device or 2D device (e.g., laptop or mobile device.) The process 1300 may be triggered upon receiving trip or travel data, upon receiving a request to generate an itinerary, and/or upon rendering a particular VR environment by a VR system (e.g., performed “just in time”).

At block 1302, the process 1300 can receive a plurality of user-generated content sequences (e.g., historical trip data). In some cases, user-generated content such as photo, videos, and reviews may be uploaded to a server for storage, which can subsequently be processed to infer information about a trip. For instance, a user might capture photos and videos as they visit different destinations throughout a day. By analyzing that photo and video data (e.g., using computer vision, analyzing the metadata, etc.), the destinations to which the user traveled can be inferred. In other implementations, the user may have created an itinerary in a web or mobile application, which can be stored and used as historical trip data. Timestamp data may be used to infer the sequence of the destination visits, which can be used by the process 1300 to derive relationships between different destinations (e.g., user visited Destinations X, Y, and Z, in that order).

At block 1304, the process 1300 can train an itinerary generator model based on the received content sequences. The itinerary generator model may include one or more machine learning models, statistical models, algorithms, and/or heuristics which be used to add context to or label the data for classification, then tune the weights, biases, coefficients, and/or hyperparameters of one or more models to develop a generative model that predicts which sequences of destinations would be enjoyed by which user(s).

At block 1306, the process 1300 can receive a request to generate an itinerary, where the request includes travel parameters (e.g., user profile, user preferences, location, date, time limitations, other constraints, restrictions, etc.). The request may be an API call, function call triggered manually or automatically (e.g., by an action in a web application, mobile application, or VR application) which initiates the process of generating a recommended travel itinerary for a particular user.

At block 1308, the process 1300 can dynamically generate a travel itinerary based on the travel parameters using the trained itinerary generator model. In some cases, the process 1300 can trigger the model to perform an inference or series of inferences whereby one or more destinations are considered relative to each destination's overall popularity, rating, and seasonality—each with respect to one or more demographic classifications or groupings. In addition, the generative model may score the likelihood that the user might enjoy a given destination if it is preceded or succeeded by another destination, based on relationships derived from the content sequence training data. The process 1300 can thereby generate sequences of one or more destinations and assign a confidence level to determine which sequence or sequences are likely to be sufficiently enjoyed by the user for which they were generated. In this manner, the process 1300 can automatically and dynamically generate an itinerary composed of recommended destinations considered to be relevant to that user.

Advances in VR technology have made it possible to create detailed 3D environments of real-world locations, such as cities, beaches, and national parks—allowing users to experience those real-world locations without having to physically travel to them. While experiencing the VR environment, a user may wish to learn more about different destinations in the area (e.g., landmarks, public parks, beaches, shops, restaurants, bars, etc.), such as viewing real-world photographs of or reading user reviews about destinations taken by other users. However, manually specifying where each piece of user-generated content should be placed within a VR environment can be a time-consuming and tedious task. With many thousands of travel locations around the world visited by people around the globe, manually geospatially mapping each piece of user content to potentially millions of destinations becomes virtually impossible.

Aspects of the present disclosure are related to a geospatial mapping system that determines a georeference for user-generated content in a VR environment modeled after a real-world location. The system processes user-generated content (e.g., images, videos, text, metadata, etc.) about a particular destination, such as a business listing, restaurant, or other location of interest to infer a geolocation associated with the content. The geospatial mapping system then maps the inferred geolocation to a georeference within the VR environment. In some implementations, a content overlay system can render a virtual object representing the user-generated content based on its determined georeference to display the content contextually with respect to the destination associated with the content. For instance, photos of a restaurant, photos of the food and drinks it serves, and reviews about the restaurant may be positioned near a virtual representation of that restaurant in a VR environment, allowing users to learn more about the restaurant from within the VR application. In effect, the system can be described as creating an augmented reality experience within a VR environment.

As described herein, the term “georeference” generally refers to a location of an object with respect to a particular coordinate system. For example, a VR environment may use an internal coordinate system to render objects within that environment. An object's georeference within the VR environment describes its location within the VR environment. A georeference may refer to specific coordinate, or a range of coordinates (e.g., a bounding rectangle, bounding polygon, or set of coordinates). For the purposes of this disclosure, the term “georeference” refers to a location with respect to a coordinate system of a virtual environment, whereas the term “geolocation” refers to a location with respect to a geographic coordinate in the physical world (e.g., longitude and latitude).

As described herein, the term “destination” generally refers to a particular business listing, restaurant, or other location of interest. A destination may be associated with an address and/or geolocation. In some cases, a destination may be a non-business location, such as a trailhead, lookout, landmark, or other location of interest. Destinations can be associated with other geospatial information, such as elevation relative to sea level, elevation relative to the street level, the floor level within a multi-story building, or a location within a building or complex (i.e., on a more granular level than a street address). Within the context of a VR environment, destinations can be associated with a reference (e.g., specific coordinate) or range of georeferences (e.g., set of coordinates).

As described herein, the term “content” generally refers to images, videos, animations, text, other media, or some combination thereof about a particular subject. For instance, content about a restaurant may include photos and/or videos of the restaurant itself, food, menus, or other media captured by users when visiting the restaurant. Content may also include text-based information, such as a name of the restaurant, a description of the restaurant, the menu, reviews about the restaurant, an address, contact information, etc. In some cases, content may be stored in association with metadata, such as the date and time that a content item was recorded and/or location information recorded when a content item was captured.

As described herein, “geospatial mapping” generally describes a process by which content is related to or associated with a particular destination. In some implementations, geospatial mapping involves analyzing a content's data and/or metadata (e.g., geolocation) to determine a georeference with which to associate the content. Geospatial mapping may involve “tagging” content with one or more georeferences, destinations, and/or other metadata such as geolocation, elevation, etc.

As described herein, rendering content “in context” generally refers to positioning content at a location in a VR environment that approximately corresponds to or is proximate to a virtual version of a real-world destination. For example, a graphical object can be rendered above, adjacent to, or proximate to a virtual coffee shop in a VR environment, with the graphical object containing content about the real-world coffee shop that the virtual coffee shop is intended to represent.

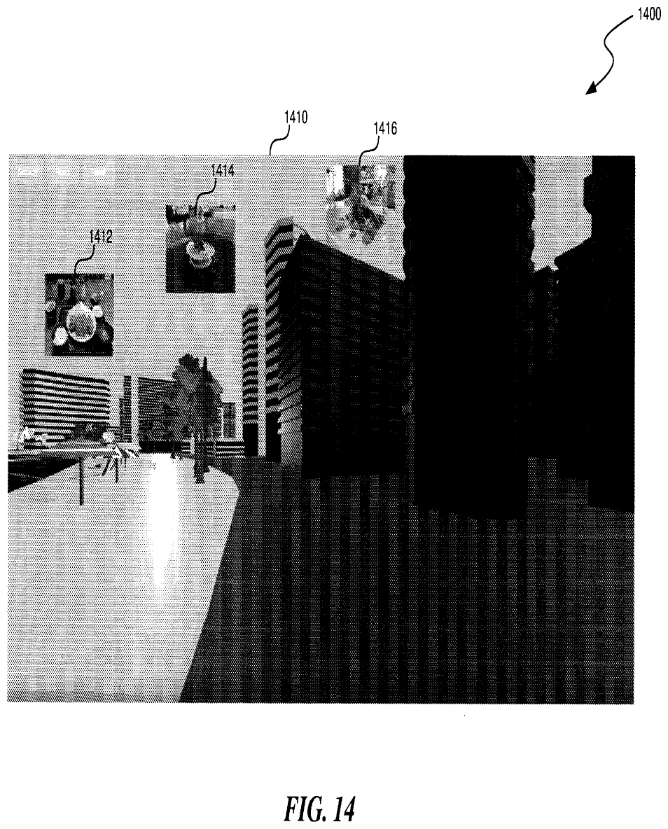

FIG. 14 is a conceptual diagram 1400 illustrating an example artificial reality travel experience with in-context photo content 1412-1416. A VR system can graphically render frame 1410 on a display of a VR device, or on an external display shown to viewers observing the VR experience without a VR headset. In this example, the VR environment includes a plurality of buildings situated along a beach front, with three of the buildings having restaurant destinations. The VR system includes virtual buttons along the top-left section of the display, allowing the user to find activities, food, or hotels in the area.

In FIG. 14, the user has pressed the “Food” virtual button to show images of dining options in the area. In this example, at least three restaurants are within the field of view (FOV) of the virtual camera used to render frame 1410: a first restaurant corresponding to photo content 1412, a second restaurant corresponding to photo content 1414, and a third restaurant corresponding to photo content 1416. Each photo content 1412-1416 is rendered proximate to the restaurant where the photo was taken, allowing users to get a quick, at-a-glance visual sense of the food options available in the area. Rather than having the user scroll through a list of options, or click on individual business listing on a mapping platform, this VR environment allows users to quickly see what kind of food is nearby the user's current location in the VR environment, while simultaneously providing the user with an intuitive sense of where each food option is located.

Consider a scenario where a user is planning out a trip and wants to visit a particular destination, such as the beach shown in frame 1410. The user can virtually travel to this destination, quickly see what dining options are nearby, and decide which restaurant or restaurants they wish to visit when they travel to this location in real life (e.g., taking into account whether the restaurant seems close enough to the beach). In some implementations, the VR environment can be rendered on a user's mobile device, enabling the user to have an augmented reality-like experience where the user holds up their mobile device and scans the area to see what dining options are nearby. In such implementations, the user can quickly identify what restaurants are nearby and intuitively know how to get there in real life.

In some cases, a restaurant may be situated within a larger building, such as on the fifth floor of a building. By rendering the user-generated content within a 3D VR environment proximate to the fifth floor of that building in the VR environment, users can gain an intuitive sense that the restaurant is not located on the ground floor of the building. For example, user-generated content may be positioned at or near the elevation of its associated destination, in contrast with other content of other destinations rendered closer to the street level elevation.

In order to render frame 1410, a geospatial mapping system may ingest and process photo content 1412-1416 to determine georeferences for each of them. For example, photo content 1412 include metadata indicating the estimated location at which the photo was taken (e.g., based on location services performed by a mobile device operating system). The geospatial mapping system can infer from the location metadata that the photo was captured at the restaurant associated with photo content 1412. For instance, the geospatial mapping system may first determine that the photo is food served at a restaurant (e.g., using image classification, object detection, or other machine learning or computer vision techniques). Then, the geospatial mapping system can determine which restaurant is nearest to the location specified in the metadata of the photo. In some implementations, the geospatial mapping system may attempt to classify the type of cuisine in the photo to improve the accuracy of the mapping process (e.g., determine that the food depicted in the photo is Japanese food, then finding the nearest restaurant that serves Japanese food).

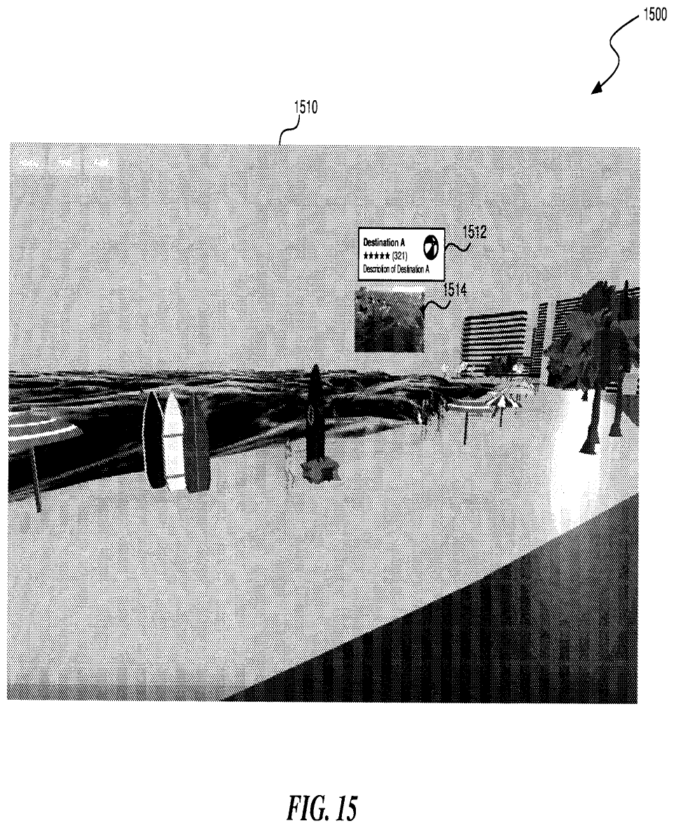

In some cases, summary information about a destination may be rendered in context that informs users about the destination. FIG. 15 is a conceptual diagram 1500 illustrating an example artificial reality travel experience with in-context photo content 1514 and summary content 1512. A user may wish to learn more about the beach in the real world, such as its name, user ratings about the beach (e.g., how clean it is, how busy it is, etc.), a brief description of the beach, and photos of what the beach looks like in the real world. The VR system can graphically render frame 1510 to include summary content 1512 and photo content 1514 positioned near the beach, allowing users to intuitively explore the beach in the VR environment and learn more about the destination. Summary content 1512 and/or photo content 1514 may be interactive virtual objects, allowing users to expand them to read a more detailed description, read user reviews, and/or see other photos of the beach.

In some implementations, computer vision techniques can be used to add contextual data to user-generated content. For example, the photo content 1514 depicts people swimming in the water. The geospatial mapping system can tag the photo content 1514 with information such as “water,” “lake,” “ocean,” or the like, which may serve as inputs to an algorithm for determining a geolocation and/or a georeference. For instance, photo content 1514 may have been captured when location services had a low confidence of the user's location (e.g., GPS was disabled and Wi-Fi signals were far away to prevent accurate triangulation). Despite the inaccuracy of the location metadata, the tag(s) may help determine approximately where the photo was taken.

As another example, optical character recognition (OCR) or similar techniques can be used to read text on signs within photos. For instance, a photo may include a sign with the name of the beach. By reading the sign, the geospatial mapping system can tag the photo with the name of the beach. In this manner, even if the location metadata is missing, tags generated when processing the photo may be sufficient to infer the location that the photo was taken.

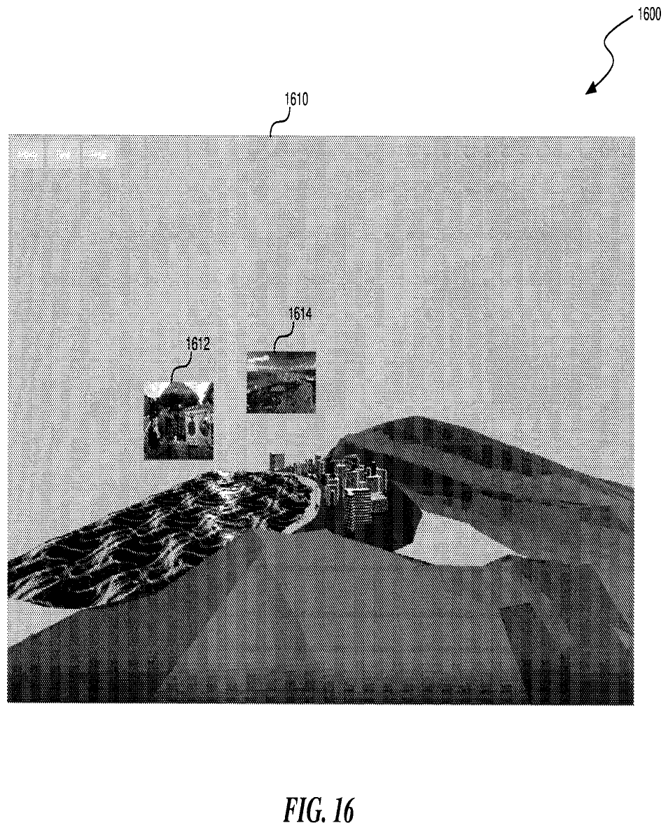

In some cases, photo content about a destination may be rendered at some distance away from the destination in a VR environment, such as from a distant vantage point. FIG. 16 is a conceptual diagram 1600 illustrating an example artificial reality travel experience with in-context photo content viewed from a distant vantage point. A user may wish to experience the view of an area from a particular vantage point, such as on top of a hill, mountain, or building. The VR system can graphically render frame 1610 to include photo content 1614 depicting what the real-world view is like from the perspective of the user's avatar in the VR environment.

In some implementations, user-generated content about destinations at a distance but within the FOV of the virtual camera may also be rendered—such as photo content 1612—to provide the user with an idea of the destinations in the area. If many destinations are present within the FOV, user-generated content from a subset of the destinations (e.g., popular destinations, destinations that match a search criteria or user preferences, etc.) may be rendered. In this manner, users can explore the VR environment to learn more about the real-world location and various destinations around that location. Photo content, such as photo content 1612, may not necessarily have been captured at or near the vantage point, and are rendered from the distant vantage point because the destination is within the FOV of the user's avatar in the VR environment.

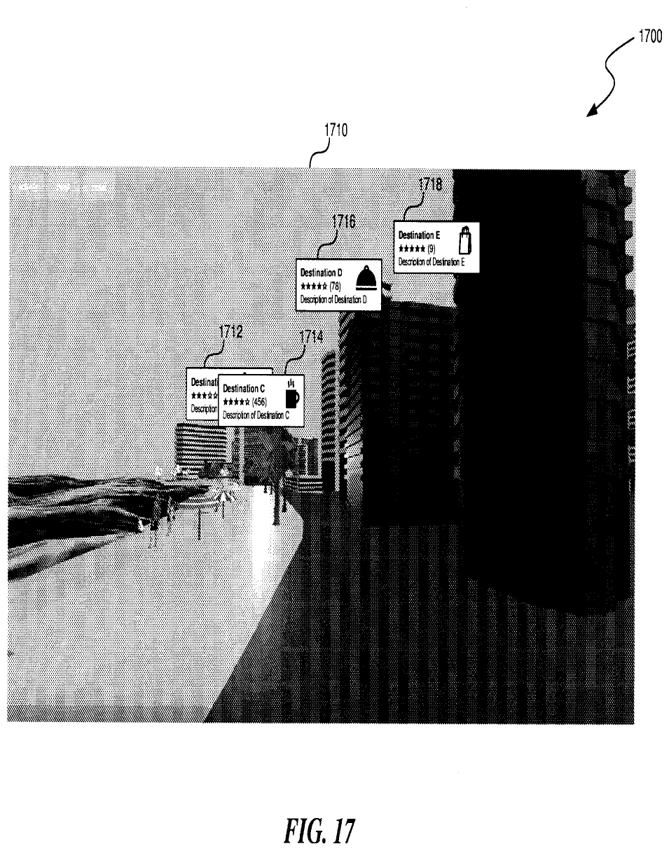

In some cases, a user may wish to view only summary content to learn about the various destinations in a particular area. FIG. 17 is a conceptual diagram 1700 illustrating an example artificial reality travel experience with in-context summary content 1712-1718. The following summary content items are rendered in frame 1710: summary content 1712 (partially obscured); summary content 1714 (coffee shop Destination C); summary content 1716 (fine dining restaurant Destination D); and summary content 1718 (gift shop Destination E). Viewing the VR environment in this manner allows the user to quickly see what destinations are in the area and how each of them are rated, which may be preferred in some cases over viewing photos of each destination.

Processes described herein in which the geospatial mapping system processes photo content can also apply to video content. For instance, video frames may be analyzed in a similar manner as photos, such that the geospatial mapping system can tag the video content with information related to the contents of the video. Videos containing multiple identifiable destinations may be associated with multiple tags so that the same video (or portions of the same video) can be associated with multiple destinations. For example, a video captured of a person walking down a street may include a coffee shop, bakery, and restaurant, all of which may be identified and tagged by the geospatial mapping system and potentially rendered proximate to each of those destinations in the VR environment.

In some scenarios, user-generated content may be captured at one location, but the subject of the user-generated content is located at some distance from where it was captured. For example, a user may capture a photo of a famous landmark (e.g., the Eiffel Tower) from a kilometer away, such that its location metadata does not match the location of the subject in the photo.

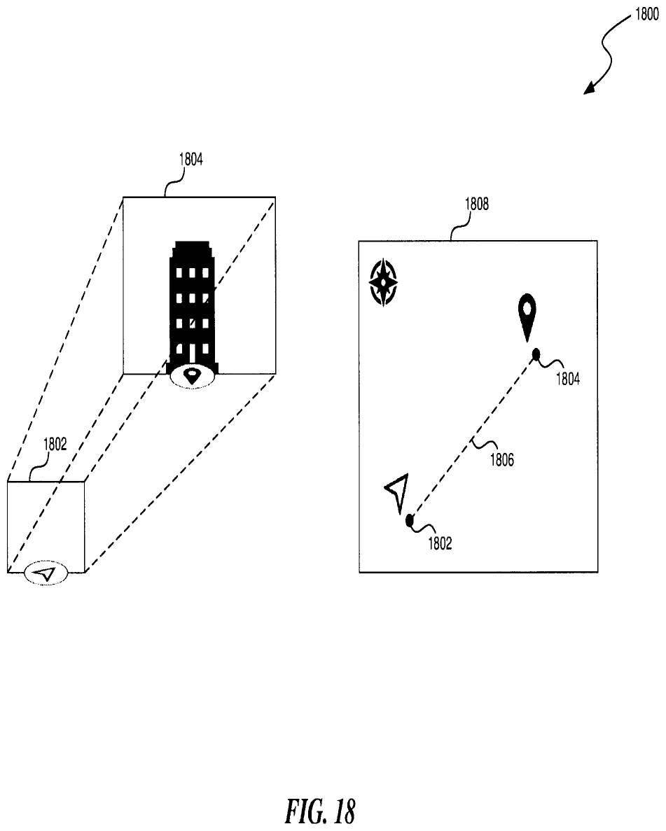

FIG. 18 is a conceptual diagram 1800 illustrating an example geospatial mapping process where the content's capture location is different from the location of the subject of the content. In this example, a user captures a photo at vantage point 1802 of a well-known building located at geolocation 1804. The geospatial mapping system might perform machine learning or computer vision techniques (e.g., image classification, reading/detecting a logo, etc.) to identify the building in the photo, to thereby infer the geolocation of the subject in the photo (e.g., the known geolocation of the building). The geospatial mapping system can, for example, compare the location metadata of the photo against the known geolocation of the building to determine a vector 1806 (as schematically illustrated in 2D map 1808).

The determined locations 1802 and 1804 and/or vector 1806 between them can be stored as tags in association with the photo, which may be used by the VR system to render user-generated content from various vantage points as the user's avatar moves about the VR environment. As one example implementation, when the user's avatar is very close to the known building in the VR environment, the photo of the building captured from the vantage point 1802 can be rendered, even though it was not captured near the building. In addition, when the user's avatar moves near vantage point 1802 and looks toward the building at geolocation 1804, the same photo of the building may be rendered as user-generated content—where it is contextually relevant due to the user's avatar's location in the VR environment corresponding to the location where the photograph was taken. In this manner, a single piece of user-generated content may be used in multiple contexts.

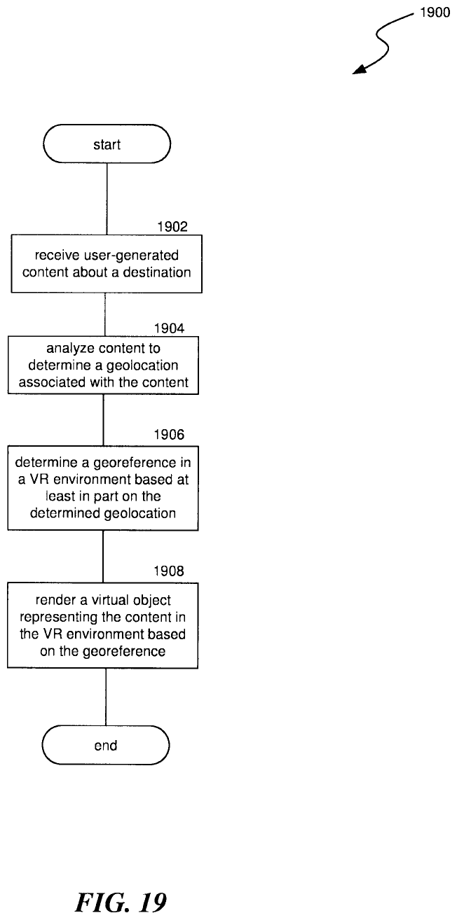

FIG. 19 is a flow diagram illustrating a process 1900 used in some implementations of the present technology for generating georeferences for displaying in-context user-generated content in a VR environment. In some implementations, process 1900 can be performed on an artificial reality device, e.g., by a sub-process of the operating system, by an environment control “shell” system, or by an executed application in control of displaying one or more objects in an artificial reality environment. The process 1900 may be triggered upon receiving user-generated content, at periodic intervals (e.g., nightly batch processing jobs), and/or upon rendering a particular VR environment by a VR system (e.g., performed “just in time”).

At block 1902, process 1900 can receive user-generated content about a destination. User-generated content may be captured on a user's device, such as a smartphone, tablet, other mobile device, personal computer, or other computing device. In some cases, user-generated content includes images and/or videos captured by the user's device, which may be stored on the user's device and uploaded to the geospatial mapping system after the images and/or videos were captured. User-generated content can also include text-based information and/or structured data such as information input by a user into a form. In various embodiments, user-generated content may include metadata associated with the content, such as the date and time the content was captured, the estimated geolocation at which the content was captured (e.g., based on GPS data, Wi-Fi triangulation, IP address, etc.), and/or other information.

At block 1904, process 1900 can analyze content to determine a geolocation associated with the content. In some embodiments, content may include location metadata recorded when the content was captured, such as GPS coordinates, estimated geolocation based on cell tower and/or Wi-Fi triangulation, geolocation estimation based on IP address, and/or geolocation based on proprietary operating system-level location services. In some implementations, geolocation information may be inferred based on the content itself (e.g., the name of a business in a review, text extracted from a photo, logo(s) identified within a photo, the known geolocation of an object detected within the image, etc.). In some embodiments, content may be associated with multiple geolocations, such as the capture location and the geolocation of the subject(s) of the content.

At block 1906, process 1900 can determine a georeference in a VR environment based at least in part on the determined geolocation. The georeference may map to a 3D location within a VR environment, with the coordinate system in the VR environment being potentially related to a range of geolocations in the real world. The georeference may relate to a geolocation where the content was captured, or may relate to the geolocation of the subject of the content. In some implementations, the georeference may be a 2D coordinate, while in other implementations the georeference may be a 3D coordinate (with the vertical coordinate corresponding to the altitude or elevation of the destination associated with the content).

At block 1908, process 1900 can render a virtual object representing the content in the VR environment based on the georeference. In some embodiments, a content overlay system can retrieve user-generated content and associated georeference data and render the user-generated content in context within a VR environment, thereby providing an augmented reality-like experience from within the VR application. In various implementations, the virtual object representing the content may be rendered proximate to (but some distance away from) the destination within the VR environment. In other words, the content may be displayed near the destination, but not directly overlapping the destination itself. The virtual object may be interactable, such that the user can view more detailed information upon interacting with the virtual object representing the content.

The implementations described herein relate to an artificial intelligence (AI)-assisted virtual object builder for an artificial reality (XR) world. The AI builder can respond to user commands to build virtual objects in the XR world. The commands can be verbal (interpreted by natural-language processing) and/or gestural (based on hand, gaze, and/or XR controller tracking). The AI builder can interpret user commands in terms of a virtual object to build and a location. Virtual objects in the XR world can include, for example, “physical” objects (e.g., virtual cars, virtual pets, virtual furniture, etc.), spaces, aspects of the surrounding environment (e.g., the sky with weather, landscape with plants), sounds, etc.

The AI builder can receive a command, from a user, that can include words, gestures, and/or images, from which the AI builder can identify an object type and object location information from the user's phrases, gestures, or images. The AI Builder can try to match the requested object type by searching a textual object description or through image matching in a library of object templates. If the type of object that the user wants built matches an item in the AI builder's library, then the AI builder can select the virtual object to build. If the type of object that the user wants to build matches multiple items in the AI builder's library, then the AI builder can present multiple candidate virtual objects to the user, from which the user can select the virtual object to build. In some implementations, the AI builder itself can automatically select the virtual object to build from among the multiple candidate virtual objects.

Once the user (or the AI builder) has selected a virtual object to build, the AI builder can identify a virtual location at which to create the object. The AI builder can determine the virtual object's location based on one or more of the nature of the virtual object, the virtual objects that already exist in the user's XR world, the physical objects that exist in the user's real-world environment, phrases or gestures from the user (such as “by the tall tree” or where the user is pointing when making the object build command), and/or a history of the user in the XR world (e.g., where the user currently is or has been, areas the user typically builds in, etc.). The AI builder can then build the selected virtual object at the identified virtual location in the XR world.

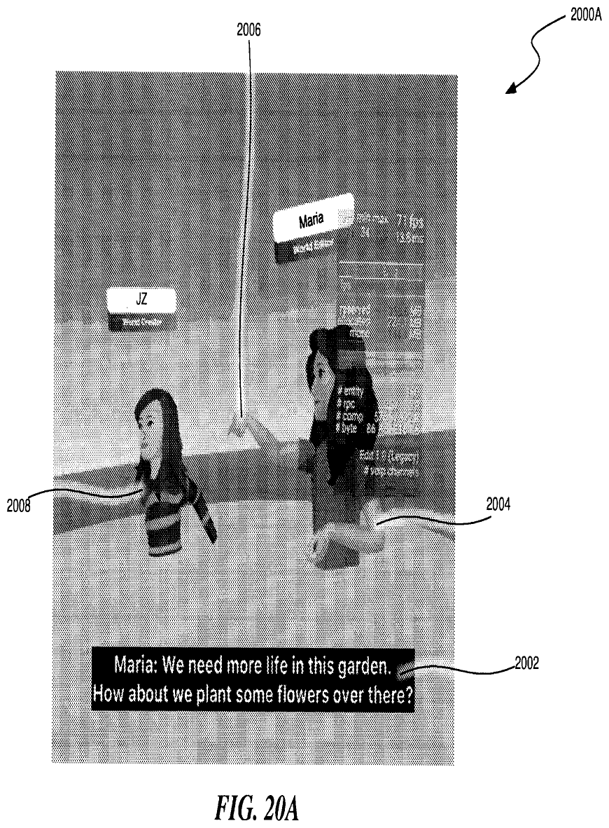

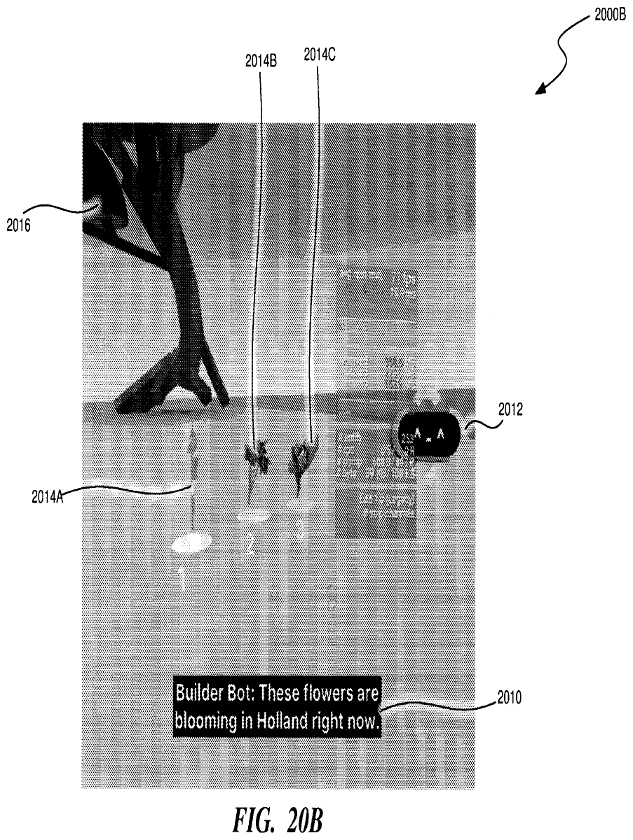

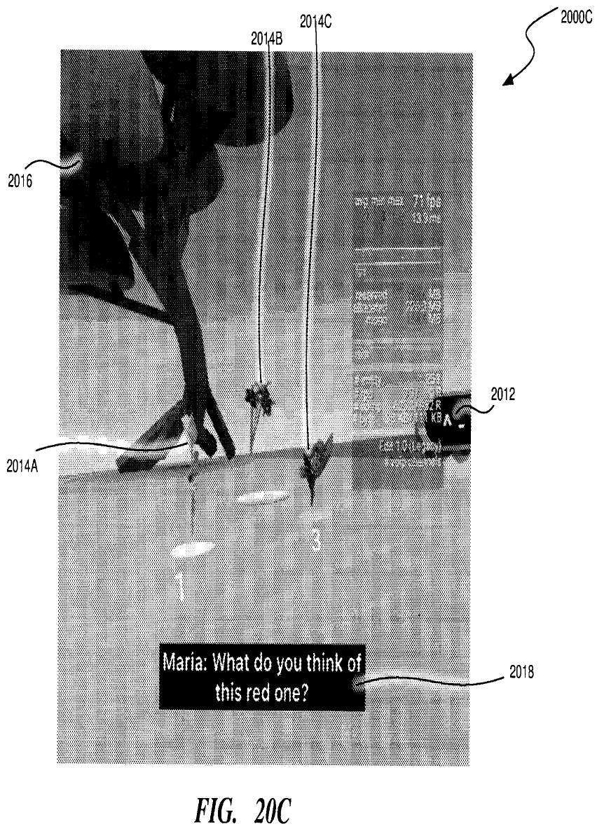

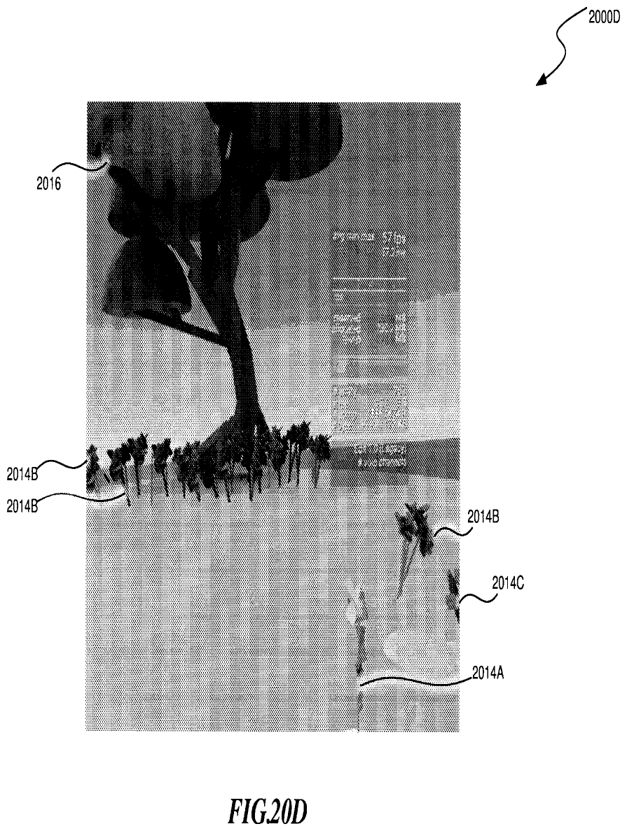

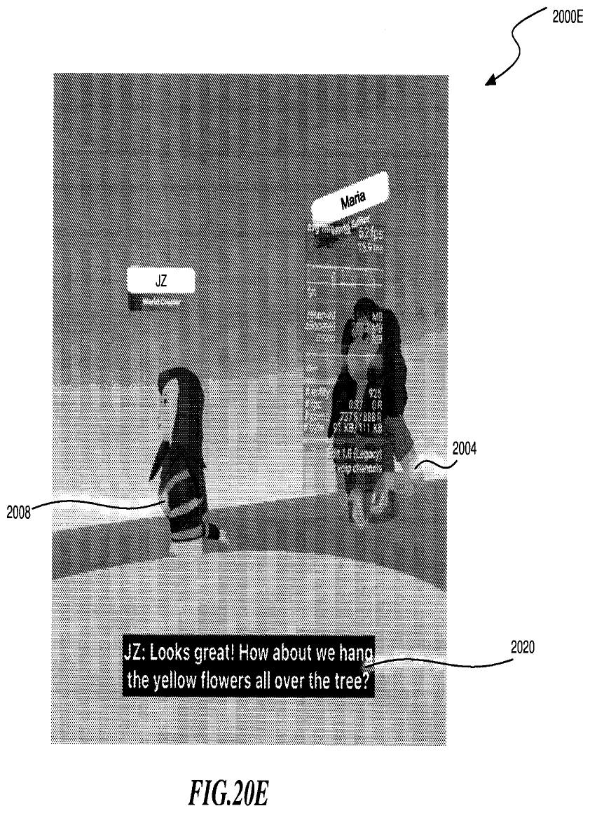

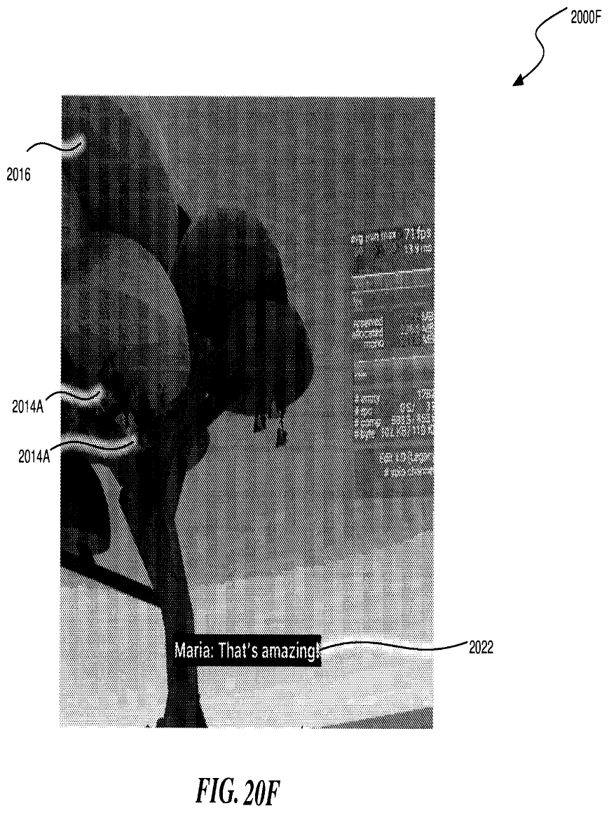

FIG. 20A is a conceptual diagram of an example XR world 2000A in which a user is making an object build command 2002 to an AI builder. XR world 2000A can include avatar 2004 associated with the user making object build command 2002 (“Maria”) and avatar 2008 associated with another user within XR world 2000A (“JZ”). In some implementations, both users associated with avatars 2004, 2008 can collaboratively build and/or edit virtual objects within XR world 2000A.

Object build command 2002, spoken audibly by the user associated with avatar 2004, states that “We need more life in this garden. How about we plant some flowers over there?” Avatar 2004 is making a gesture 2006 toward a particular location in XR world 2000A in response to, for example, detection of a real-world gesture by the user associated with avatar 2004, such as via a controller associated with an XR device. In response to receiving object build command 2002, the AI builder can parse object build command 2002 for an object type (e.g., “flowers”) and object location information (e.g., “over there” and gesture 2006). Based on the object type (e.g., “flowers”), the AI builder can identify a plurality of candidate virtual objects.

FIG. 20B is a conceptual diagram of an example XR world 2000B in which the AI builder is presenting options of candidate virtual objects 2014A-C and contextual information 2010 based on object build command 2002. Based on the object type (e.g., “flowers”), the AI builder can identify candidate virtual objects 2014A-C that are of the object type and facilitate presentation of candidate virtual objects 2014A-C. In the example shown in FIG. 20B, candidate virtual object 2014A is a yellow flower, candidate virtual object 2014B is a red flower, and candidate virtual object 2014C is a purple flower. The AI builder can further facilitate presentation of contextual information 2010 relevant to candidate virtual objects 2014A-C (e.g., “These flowers are blooming in Holland right now.”). In some implementations, XR world 2000B can include other virtual objects as well, such as virtual tree 2016 and visual representation 2012 of the AI builder (i.e., a non-player character), to ease collaboration among the users associated with avatars 2004, 2008).

FIG. 20C is a conceptual diagram of an example XR world 2000C in which the user associated with avatar 2004 is selecting a virtual object 2014B from candidate virtual objects 2014A-C. To select virtual object 2014B, the user can speak indication 2018 selecting virtual object 2014B (e.g., “What do you think of this red one?”). In some implementations, the AI builder can highlight selected virtual object 2014B to confirm indication 2018 of selecting virtual object 2014B.

FIG. 20D is a conceptual diagram of an example XR world 2000D in which the AI builder is building the selected virtual object 2014B in the XR world 2010D according to a virtual location identified from object build command 2002. In FIG. 20D, the AI builder is building virtual objects 2014B corresponding to red flowers by tree 2016, in the virtual location indicated by gesture 2006 of the user of avatar 2004.

FIG. 20E is a conceptual diagram of an XR world 2000E in which the user associated with avatar 2008 (e.g., “JZ”) is making a further object build command 2020 to the AI builder. Object build command 2020 states, “Looks great! How about we hang the yellow flowers all over the tree?” In response to receiving object build command 2020, the AI builder can parse object build command 2020 for an object type (e.g., “yellow flowers”) and object location information (e.g., “all over the tree”). Based on the object type (e.g., “yellow flowers”), the AI builder can identify virtual object 2014A.

FIG. 20F is a conceptual diagram of an example XR world 2000F in which the AI builder is building a further selected virtual object 2014A in XR world 2000F according to virtual location identified from further object build command 2020. In FIG. 20F, AI builder is building virtual objects 2014A corresponding to yellow flowers on tree 2016, i.e., the virtual location indicated by object build command 2020. In some implementations, the AI builder can receive feedback 2022 (e.g., “That's amazing!”) regarding whether the correct virtual objects 2014A were built and in the desired location. In some implementations, the AI builder can receive other feedback (not shown) indicating that virtual objects 2014A should be edited, such as to be a different color, a different size, in a different location, etc.

It is contemplated that multiple users associated with different avatars (e.g., avatars 2004, 2008) can provide object build commands and/or object edit commands to the AI builder. For example, in FIG. 20A, the user associated with avatar 2004 can provide object build command 2002, while in FIG. 20E, the user associated with avatar 2008 can provide object build command 2020. Thus, multiple users can work collaboratively to build and/or edit virtual objects within XR worlds 2000A-100F in some implementations.

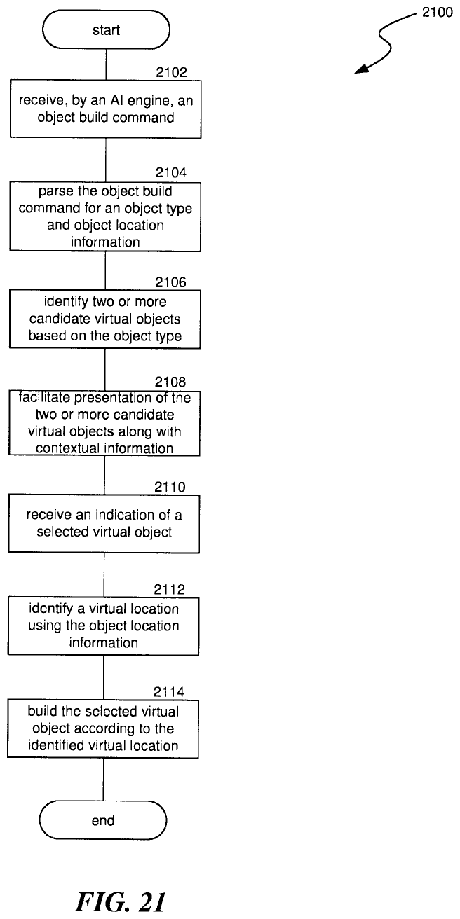

FIG. 21 is a flow diagram illustrating a process 2100 used in some implementations for building a selected virtual object, of a plurality of virtual objects, in an artificial reality (XR) world. In some implementations, process 2100 can be performed as a response to receiving an object build command from a user via an XR device. In some implementations, process 2100 can be performed by the XR device and/or other components of an XR system in communication with the XR device. In some implementations, process 2100 can be performed by a server located remotely from the XR device. In some implementations, some blocks of process 2100 can be performed by the XR device (and/or other components of the XR system), while others can be performed by the remote server. In some implementations, process 2100 can be performed by the artificial intelligence (AI) builder described herein.

At block 2102, process 2100 can receive, by an AI engine (e.g., an AI builder), an object build command. In some implementations, the object build command can be a verbal command, a user gesture, input from an XR controller, or a combination of these. In some implementations, process 2100 can receive stream of user audio (i.e., a verbal command) from an XR device, which can be streamed to a speech recognition engine. In some implementations, process 2100 can detect a gesture by a user, e.g., as captured from cameras integral with an XR system and/or XR device, and/or as captured by the XR controller.

At block 2104, process 2100 can parse the object build command for an object type and object location information. In some implementations, a verbal user command as recognized by the speech recognition engine can be forwarded to a natural language processing engine to parse the object build command (e.g., by applying various machine learning models, key phrase recognizers, etc.) to identify the object type (e.g., a virtual flower, tree, car, etc., and/or a genre of objects such as bedroom furniture, beach objects, etc.) and/or object location information (e.g., “over there,” “near the tree,” “around me,” etc.). In some implementations, process 2100 can identify the object location information from a gesture, e.g., a pointing motion. In some implementations, if the object build command does not provide sufficient information to parse the object type and/or object location information, process 2100 can query the user via the XR device (and/or one or more other users within the XR world via respective other XR devices) for further instructions.

At block 2106, process 2100 can identify two or more candidate virtual objects from the plurality of virtual objects based on the object type. In some implementations, process 2100 can identify the two or more candidate virtual objects by querying a database of virtual objects with the object type. For example, for an object type of a vehicle, process 2100 can query a database of virtual vehicles and identify a virtual convertible, motorcycle, truck, etc. In some implementations, if many candidate virtual objects meet the object type, process 2100 can facilitate presentation of clarifying queries to the user via the XR device (or one or more other users within the XR world) to further narrow the field of candidate virtual objects.

In some implementations, process 2100 can identify the two or more candidate virtual objects based on metadata associated with the user. The metadata can include, for example, the user's interests, the user's demographics, virtual objects previously built by the user, etc. In some implementations, process 2100 can identify the two or more candidate virtual objects based on aggregated data associated with a plurality of users, such as trending virtual objects, i.e., virtual objects frequently being selected by other users. In some implementations, process 2100 can identify the two or more candidate virtual objects based on data related to other users associated with the user (e.g., a user's friends, other users in the XR world, other users having metadata in common with the user such as demographics, etc.).

In some implementations, process 2100 can identify the two or more candidate virtual objects based on other virtual objects in the XR world, e.g., have one of more attributes in common with the other virtual objects in the XR world. For example, if the XR world includes a beach scene, process 2100 can select candidate virtual objects that are tropical, instead of, e.g., candidate virtual objects associated with the desert. In another example, if the XR world includes blooming flowers, process 2100 can select candidate virtual objects (e.g., virtual trees) that bloom, instead of candidate virtual objects that do not bloom (e.g., fir trees, pine trees, etc.).

At block 2108, process 2100 can facilitate presentation of the two or more candidate virtual objects along with contextual information associated with the two or more candidate virtual objects. Process 2100 can facilitate presentation of the two or more candidate virtual objects by, for example, providing rendering data for the two or more candidate virtual objects to the XR device (e.g., when process 2100 is performed by a remote server), and/or rendering the two or more candidate virtual objects on the XR device (e.g., when process 2100 is performed by the XR device and/or other components of an XR system in communication with the XR device). In some implementations, process 2100 can facilitate audible and/or visual presentation of the candidate virtual objects and the contextual information. In some implementations, when process 2100 facilitates virtual presentation of the candidate virtual objects, the candidate virtual objects can be two-dimensional (2D) and/or three-dimensional (3D).

In some implementations, the contextual information can enrich the two or more candidate virtual objects with additional details such that process 200 can provide further information regarding the candidate virtual objects in addition to merely presenting the candidate virtual objects. In some implementations, process 200 can query a database of information (e.g., an online or stored encyclopedia, a social media platform, news items, etc.) for contextual information associated with the candidate virtual objects. For example, if the two or more candidate virtual objects are trees, process 200 can facilitate presentation of additional data about the trees (e.g., “these trees are blooming now,” “the oak tree is common,” “the cherry blossom tree originated in Japan,” etc.).

At block 2110, process 2100 can receive an indication of the selected virtual object from amongst the two or more candidate virtual objects. For example, a user can select, via the XR device (or other components of the XR system, such as a controller), a virtual object from amongst the two or more candidate virtual objects presented by the XR device. The indication of the selected virtual object can be, for example, an audible indication (e.g., “I like the red one”), a physical selection (e.g., a selection of a physical button on a controller), a virtual selection (e.g., a selection of a virtual button displayed on the XR device), a gesture indication (e.g., a user pointing at a particular virtual object, as detected by one of more cameras associated or integral with the XR device, by a controller, etc.), and/or the like.

In some implementations, process 2100 can apply a probabilistic model to determine whether or not to perform block 2108, i.e., whether to facilitate presentation of the two or more candidate virtual objects. Process 2100 can train the probabilistic mode based on data such as, for example, whether the user always (or usually, e.g., above a threshold) selects to be presented with candidate virtual objects, whether the user never (or usually doesn't, e.g., below a threshold) selects to be presented with candidate virtual objects, whether the user always (or usually, e.g., above a threshold) selects a particular candidate virtual object (e.g., the first presented candidate virtual object, the last predicted candidate virtual object, etc.), the amount of time it takes for a user to select a candidate virtual object (e.g., a long selection time indicating that the user is considering the options or a short selection time indicating that the user just picked something), etc. In implementations in which block 2108 is not performed, process 2100 can generate the indication of the selected virtual object at block 2110 automatically, without further input from the user.

At block 2112, process 2100 can identify a virtual location in the XR world using the object location information. In some implementations, process 2100 can identify the virtual location based on one or more of the nature of the selected virtual object, the virtual objects that already exist in the XR world, physical objects that already exist in a user's real-world environment, phrases or gestures by the user (e.g., “by the tall tree” or where the user is pointing when making the object build command), and/or a history of the user in the XR world (e.g., where the user's avatar currently is or has been in the XR world, areas in the XR world that the user typically builds in, etc.). In some implementations, process 2100 can understand the nature of the selected virtual object that it will build and can act in accordance with that nature. For example, a house's nature generally requires that it should be built on the ground and in a large enough open area; thus, process 2100 can identify a suitable virtual location in the XR world meeting those requirements.

At block 2114, process 2100 can build the selected virtual object in the XR world according to the identified virtual location. In some implementations, prior to and/or upon building the selected virtual object, process 2100 can edit the selected virtual object through further commands. For example, process 2100 can receive an object edit command from the user via his XR device to change the color of the selected virtual object, to change the size of the selected virtual object, to change the virtual location of the selected virtual object, etc.

In some implementations, process 2100 can be performed only when a received object build command is ambiguous, i.e., when process 2100 cannot ascertain a particular virtual object to build based on the object build command and/or when two or more candidate virtual objects meet the requirements specified by the object build command. For example, for an object build command of, “I want to build a bedroom,” multiple virtual objects can correspond to items typically included in a bedroom; thus, process 2100 can be performed. In another example, for an object build command of, “I want to add a virtual Golden Retriever,” process 2100 may not be performed if only one virtual Golden Retriever is available in a database of virtual objects.

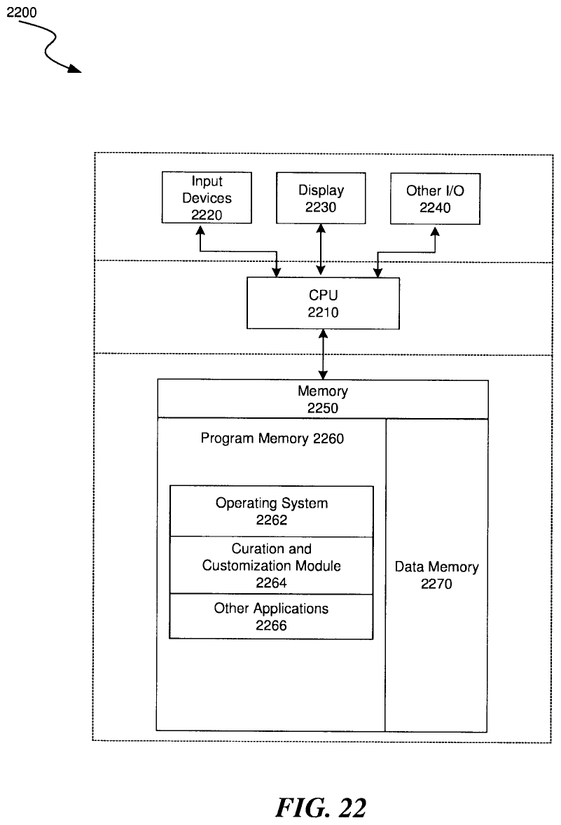

FIG. 22 is a block diagram illustrating an overview of devices on which some implementations of the disclosed technology can operate. The devices can comprise hardware components of a device 2200 as shown and described herein. Device 2200 can include one or more input devices 2220 that provide input to the Processor(s) 2210 (e.g., CPU(s), GPU(s), HPU(s), etc.), notifying it of actions. The actions can be mediated by a hardware controller that interprets the signals received from the input device and communicates the information to the processors 2210 using a communication protocol. Input devices 2220 include, for example, a mouse, a keyboard, a touchscreen, an infrared sensor, a touchpad, a wearable input device, a camera- or image-based input device, a microphone, or other user input devices.

Processors 2210 can be a single processing unit or multiple processing units in a device or distributed across multiple devices. Processors 2210 can be coupled to other hardware devices, for example, with the use of a bus, such as a PCI bus or SCSI bus. The processors 2210 can communicate with a hardware controller for devices, such as for a display 2230. Display 2230 can be used to display text and graphics. In some implementations, display 2230 provides graphical and textual visual feedback to a user. In some implementations, display 2230 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2240 can also be coupled to the processor, such as a network card, video card, audio card, USB, firewire or other external device, camera, printer, speakers, CD-ROM drive, DVD drive, disk drive, or Blu-Ray device.

In some implementations, the device 2200 also includes a communication device capable of communicating wirelessly or wire-based with a network node. The communication device can communicate with another device or a server through a network using, for example, TCP/IP protocols. Device 2200 can utilize the communication device to distribute operations across multiple network devices.

The processors 2210 can have access to a memory 2250 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2250 can include program memory 2260 that stores programs and software, such as an operating system 2262, Curation and Customization Module 2264, and other application programs 2266. Memory 2250 can also include data memory 2270, which can be provided to the program memory 2260 or any element of the device 2200.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

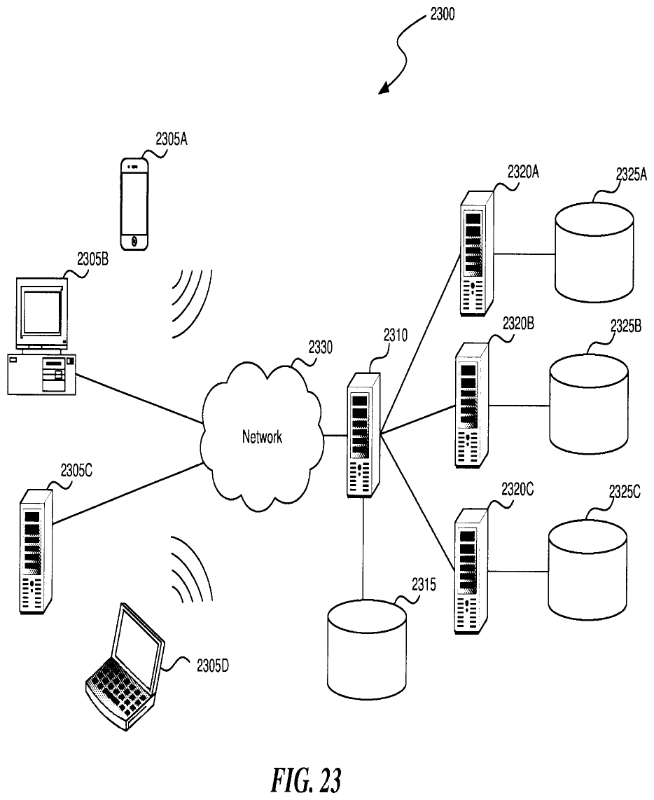

FIG. 23 is a block diagram illustrating an overview of an environment 2300 in which some implementations of the disclosed technology can operate. Environment 2300 can include one or more client computing devices 2305A-D, examples of which can include device 2200. Client computing devices 2305 can operate in a networked environment using logical connections through network 2330 to one or more remote computers, such as a server computing device.

In some implementations, server 2310 can be an edge server which receives client requests and coordinates fulfillment of those requests through other servers, such as servers 2320A-C. Server computing devices 2310 and 2320 can comprise computing systems, such as device 2200. Though each server computing device 2310 and 2320 is displayed logically as a single server, server computing devices can each be a distributed computing environment encompassing multiple computing devices located at the same or at geographically disparate physical locations. In some implementations, each server 2320 corresponds to a group of servers.

Client computing devices 2305 and server computing devices 2310 and 2320 can each act as a server or client to other server/client devices. Server 2310 can connect to a database 2315. Servers 2320A-C can each connect to a corresponding database 2325A-C. As discussed above, each server 2320 can correspond to a group of servers, and each of these servers can share a database or can have their own database. Databases 2315 and 2325 can warehouse (e.g., store) information. Though databases 2315 and 2325 are displayed logically as single units, databases 2315 and 2325 can each be a distributed computing environment encompassing multiple computing devices, can be located within their corresponding server, or can be located at the same or at geographically disparate physical locations.

Network 2330 can be a local area network (LAN) or a wide area network (WAN), but can also be other wired or wireless networks. Network 2330 may be the Internet or some other public or private network. Client computing devices 2305 can be connected to network 2330 through a network interface, such as by wired or wireless communication. While the connections between server 2310 and servers 2320 are shown as separate connections, these connections can be any kind of local, wide area, wired, or wireless network, including network 2330 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. Patent Application No. 207/170,839, titled “INTEGRATING ARTIFICIAL REALITY AND OTHER COMPUTING DEVICES,” filed Feb. 8, 2021 and now issued as U.S. Patent No. 201,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following: A method for building a selected virtual object, of a plurality of virtual objects, in an artificial reality world, the method comprising: receiving, by an artificial intelligence engine, an object build command; parsing the object build command for an object type; identifying two or more candidate virtual objects from the plurality of virtual objects based on the object type; facilitating presentation of the two or more candidate virtual objects along with contextual information associated with the two or more candidate virtual objects; receiving an indication of the selected virtual object from amongst the two or more candidate virtual objects; identifying a virtual location in the artificial reality world; and building the selected virtual object in the artificial reality world according to the identified virtual location.

I/we claim:

1. A method for creating a customized pet avatar using artificial intelligence, the method comprising:
analyzing one or more real-world images of a pet to identify a plurality of physical features of the pet, the plurality of physical features including a color of the pet;
matching the plurality of physical features of the pet to a graphical model of a plurality of graphical models stored in a database, the graphical model corresponding to a predetermined animal;
applying the color of the pet to the graphical model; and
facilitating display of the graphical model as the customized pet avatar.

2. A method for automatically generating a travel itinerary for a user, the method comprising:
receiving a plurality of user-generated content sequences associated with a set of first users;
training a temporal itinerary generator model based at least in part on the plurality of user-generated content sequences associated with the first set of users;
receiving a request to generate an itinerary for a second user, wherein the request includes one or more travel parameters indicating at least one of the following: (i) preferences associated with the second user, (ii) a travel location, (iii) a travel date, and (iv) a time limit; and
automatically generating the itinerary for the second user using the trained temporal itinerary generator model and the one or more travel parameters.

3. A method for geospatially mapping user-generated content within a VR environment, the method comprising:
receiving user-generated content associated with a destination;
processing the user-generated content to infer a geolocation associated with the user-generated content;
mapping the inferred geolocation to a georeference within a VR environment based at least in part on the inferred geolocation; and
rendering a virtual object representing the user-generated content within the VR environment at a position based on the georeference.
